(19) United States
(12) Patent Application Publication
(10) Pub. No.: US 2026/0214676 A1
(43) Pub. Date: Jul. 23, 2026

(54) UE-INITIATED REFERENCE SIGNAL TRANSMISSION

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US); Md. Saifur Rahman, Plano, TX (US)

(21) Appl. No.: 19/435,707

(22) Filed: Dec. 29, 2025

Related U.S. Application Data
(60) Provisional application No. 63/746,721, filed on Jan. 17, 2025.
(60) Provisional application No. 63/750,029, filed on Jan. 27, 2025.
(60) Provisional application No. 63/757,595, filed on Feb. 12, 2025.

(51) Int. Cl. H04W 72/21; H04L 5/00

(52) U.S. Cl. CPC H04W 72/21; H04L 5/00

(57) ABSTRACT

Methods and apparatuses for user equipment (UE)-initiated reference signal (RS) transmission. A method performed by a UE includes receiving a configuration for one or more RS resources for UE-initiated RS transmission, transmitting, on a physical uplink control channel (PUCCH) resource, a first message indicating information related to the one or more RS resources, and receiving, in response to the first message, a second message including an indicator. The method further includes receiving, based on the configuration and the indicator, one or more RSs, determining a measurement report from the one or more RSs, and transmitting, via a physical uplink shared channel (PUSCH) resource, the measurement report.

### CROSS-REFERENCE TO RELATED AND CLAIM OF PRIORITY

The present application claims priority under 35 U.S.C. § 119 (e) to: U.S. Provisional Patent Application No. 63/746,721 filed Jan. 17, 2025, U.S. Provisional Patent Application No. 63/750,029 filed Jan. 27, 2025, and U.S. Provisional Patent Application No. 63/757,595 filed Feb. 12, 2025, each of which are hereby incorporated by reference in their entirety.

### TECHNICAL FIELD

The present disclosure relates generally to wireless communication systems and, more specifically, to uplink user equipment (UE)-initiated reference signal (RS) transmission.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated RS transmission.

In one embodiment, a UE is provided. The UE includes a transceiver configured to receive a configuration for one or more RS resources for UE-initiated RS transmission, transmit, on a physical uplink control channel (PUCCH) resource, a first message indicating information related to the one or more RS resources, receive, in response to the first message, a second message including an indicator, and receive, based on the configuration and the indicator, one or more RSs. The UE further includes a processor operably coupled with the transceiver. The processor configured to determine a measurement report from the one or more RSs. The transceiver is further configured to transmit, via a PUSCH resource, the measurement report.

In another embodiment, a base station (BS) is provided. The BS includes a processor and a transceiver operably coupled with the processor. The transceiver is configured to transmit a configuration for one or more RS resources for UE-initiated RS transmission, receive, on a PUCCH resource, a first message indicating information related to the one or more RS resources, transmit, in response to the first message, a second message including an indicator, transmit, based on the configuration and the indicator, one or more RSs, and receive, via a PUSCH resource, a measurement report that is based on the one or more RSs.

In yet another embodiment, a method performed by a UE is provided. The method includes receiving a configuration for one or more RS resources for UE-initiated RS transmission, transmitting, on a PUCCH resource, a first message indicating information related to the one or more RS resources, and receiving, in response to the first message, a second message including an indicator. The method further includes receiving, based on the configuration and the indicator, one or more RSs, determining a measurement report from the one or more RSs, and transmitting, via a PUSCH resource, the measurement report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIGS. 7A and 7B illustrate an example timeline for time window determination according to embodiments of the present disclosure;

FIG. 8 illustrates an example of UE-initiated measurement RS(s) transmission for CSI measurement/reporting according to embodiments of the present disclosure; and

FIG. 9 illustrates an example method performed by a UE in a wireless communication system according to embodiments of the present disclosure.

### DETAILED DESCRIPTION

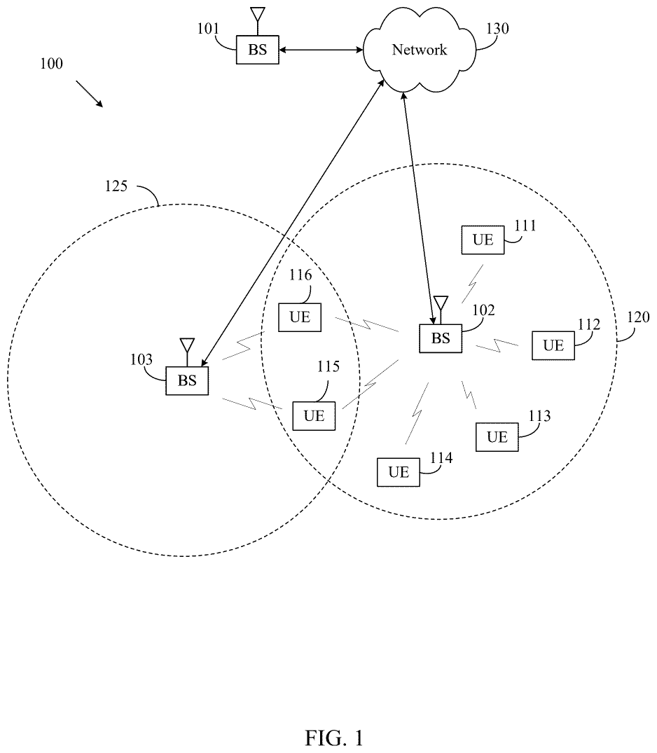

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1] 3GPP TS 38.211 v16.1.0, “NR; Physical channels and modulation;” [REF 2] 3GPP TS 38.212 v16.1.0, “NR; Multiplexing and Channel coding;” [REF 3] 3GPP TS 38.213 v16.1.0, “NR; Physical Layer Procedures for Control;” [REF 4] 3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for UE-initiated RS transmission. In certain embodiments, one or more of the BSs 101-103 include circuitry, programing, or a combination thereof to support UE-initiated RS transmission.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

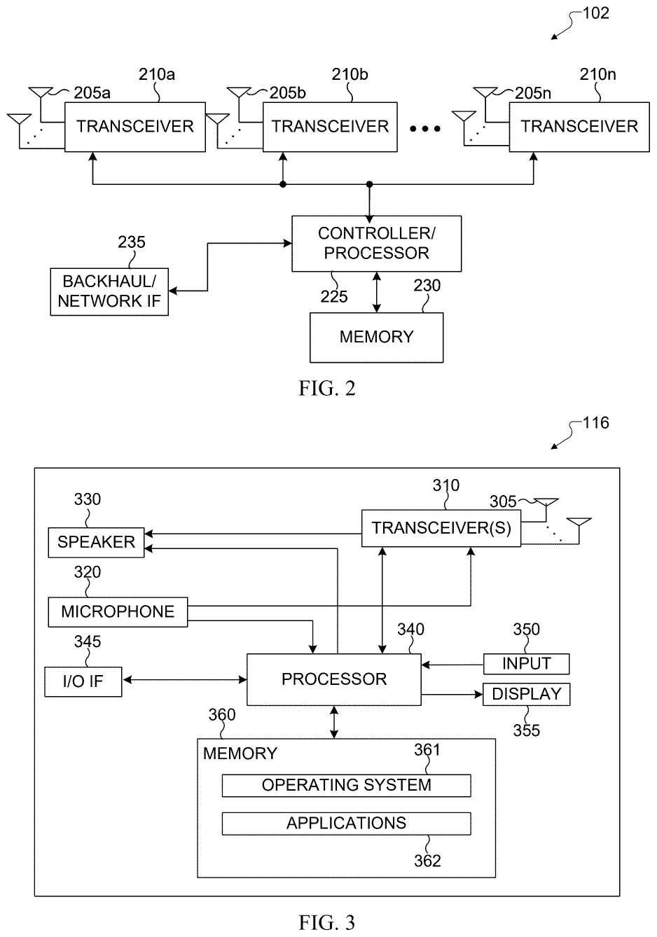

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for CSI configurations in TDD scenarios. Any of a wide variety of other functions could be supported in the gNB 102 by the controller/processor 225.

The controller/processor 225 is also capable of executing programs and other processes resident in the memory 230, such as processes to support UE-initiated RS transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UE-initiated RS transmission as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

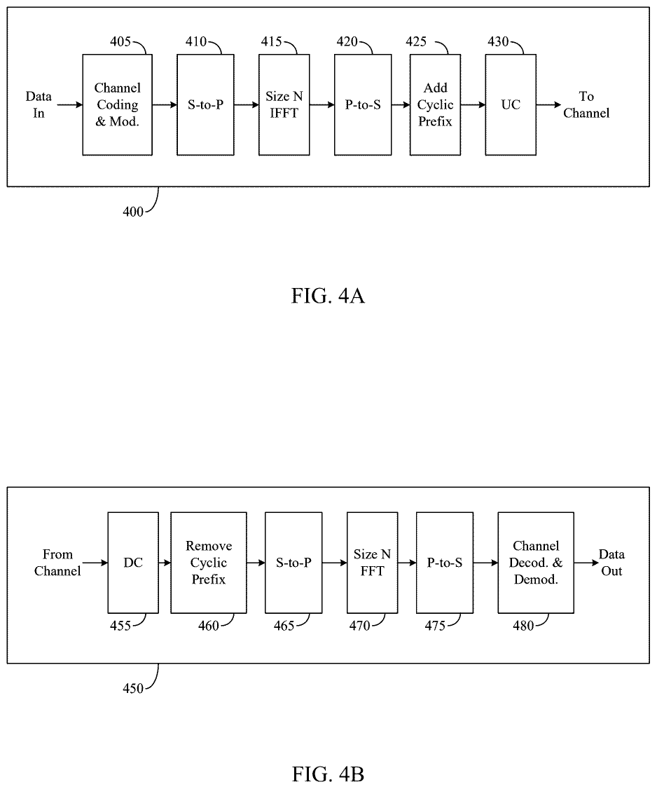

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for UE-initiated RS transmission as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

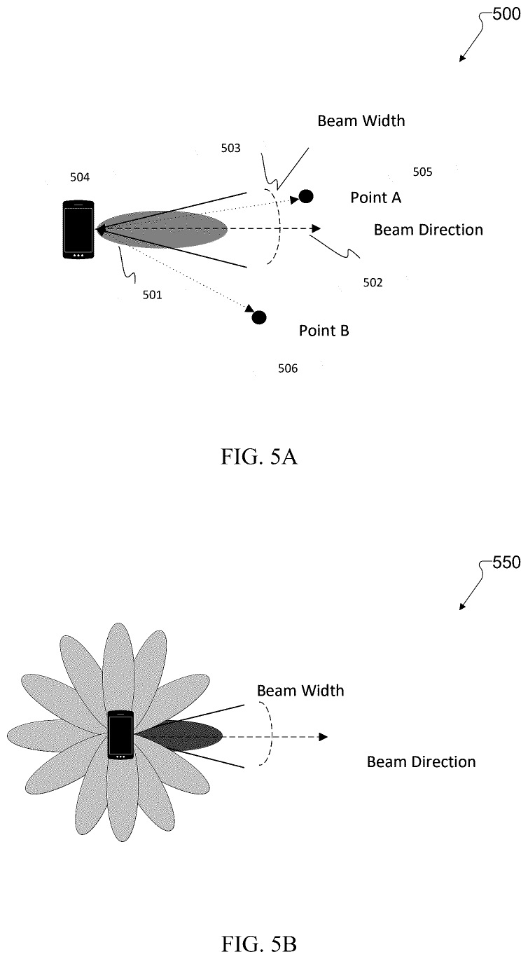

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art that a beam can be 3D, where a beam can be transmitted to or received from any direction in space.

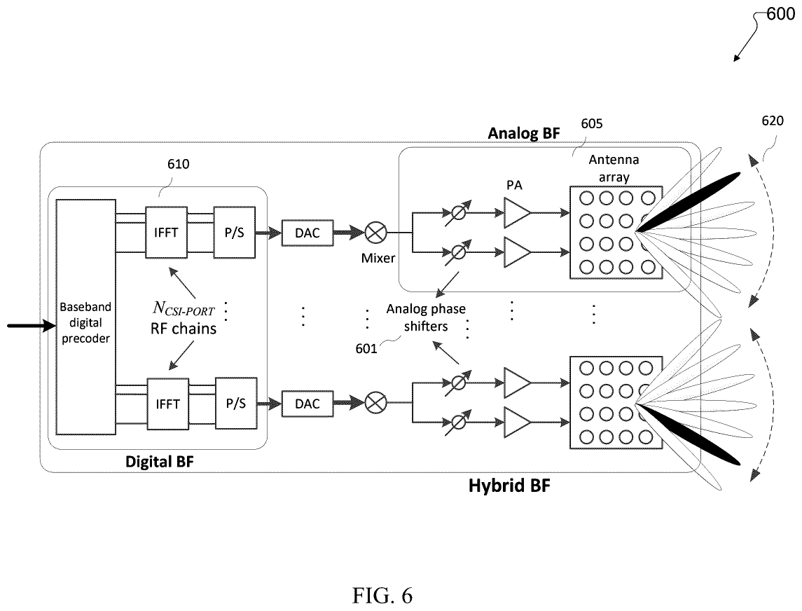

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NcsI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are needed to compensate for the additional path loss.

In this disclosure, a beam is determined by either of;
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure recognize that in (up to Rel.17) the NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), and/or multiple event types when a report type can be associated with an event (e.g., for beam report, the event can be beam failure, and for CSI, the event can be user throughput degradation or increasing retransmission rate).

The present disclosure provides various novel and detailed design examples on UE-initiated (UEI) measurement reference signals (RSs) transmission(s) for CSI measurement and reporting. Further, the present disclosure provides various novel and detailed design examples on the UE-initiated/event-driven beam management framework including UE-initiated/event-driven measurement reference signals (RSs) transmission(s). To better support/enable the UE-initiated/event-based beam operations, this disclosure presents example embodiments on means and/or procedures of UE to activate/deactivate measurement RS resource(s) and/or indicate configuration information for the measurement RS(s)/RS resource(s).

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g., NW/gNB (e.g., the network 130/the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g., channel quality indicator (CQI) report interval (CRI), SSB resource indicator (SSBRI)) and Jᵢ is a beam metric (e.g., L1-reference signal received power (RSRP), L1-signal-to-interference-plus-noise ratio (SINR)).
In one example, the content includes CSI-related quantity/quantities. For example, at least one of: rank indicator (RI), precoding matrix indicator (PMI), channel quality indicator (CQI), CQI report interval (CRI), layer index (LI).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g., (auto-) correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either
      beam (TCI state) TCI states (e.g., DL TCI state, UL TCI state, or unified (joint) DL/UL TCI state), or
      panel(s) (e.g., UE panels for DL reception or/and UL transmission), or
      antenna (e) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g., this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE (e.g., the UE 116) can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/beam/ | (A) | Yes (e.g., non-CSI-related event) | No |
| TDCP | (B) | No | Yes |
| | (C) | Yes (e.g., non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g., beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g., CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g., from Type I to Type II or vice versa), or rank restriction (e.g., from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g., CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g., MCS, or number of CWs.
For another example, when there is no pre-notification message/trigger associated with a content, i.e., the report-type is (B), the content can be transmitted using UL resource(s) configured (e.g., configured-grant physical uplink shared channel (PUSCH)), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

Under the aforementioned unified TCI framework, a UE could receive a (unified) TCI state(s) activation/deactivation (MAC CE) command, used to map up to a number of activated TCI states and/or pairs of activated TCI states, with one activated TCI state for DL channels/signals and/or one activated TCI state for UL channels/signals to the codepoints of the DCI field ‘Transmission Configuration Indication’ for one or for a set of CCs/DL BWPs, and if applicable, for one or for a set of CCs/UL BWPs. That is, a UE could receive from the network, in/via a (unified) TCI state(s) activation/deactivation (MAC CE) command, up to a number of TCI codepoints of the DCI field ‘Transmission Configuration Indication’ for one or for a set of CCs/DL BWPs, and if applicable, for one or for a set of CCs/UL BWPs with each TCI codepoint mapped to an activated TCI state and/or a pair of activated TCI states, with one activated TCI state for DL channels/signals and/or one activated TCI state for UL channels/signals. In the present disclosure, an activated TCI state can also be referred to as an activated beam, and vice versa.

The RS(s) or RS resource(s) or RS resource index(es) of/for a current serving beam-denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set 5% of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure.
(explicit configuration example-2): a set s̅₀ of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set 5% of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam-denoted by actual candidate/new beam RS(s) or RS resource(s) or RS resource index(es)—could be identified or determined according to one or more of:
(explicit configuration example-A): a set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-B): a set s̅₁ of SS/PBCH block indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state-denoted by activation beam RS(s) or RS resource(s) or RS resource indexe(s)—could be identified or determined according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-i): a set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-ii): a set s̅₂ of SS/PBCH block indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring L1-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to)
   one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking reference signal (TRS)—e.g., a CSI-RS configured with trs-Info, a CSI-RS configured without repetition or with repetition set to ‘off’, and etc.

A UE could determine or identify an instance of a first event (or an Event-1 instance) according to or based on or corresponding to: the UE could determine or identify at least one (same) candidate/new beam or candidate/new beam RS/RS resource that has a beam quality/metric (e.g., a measured L1-RSRP/L1-SINR) a threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or an Event-2 instance) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or an Event-3 instance) according to or based on or corresponding to: the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources as specified/defined herein in the present disclosure; furthermore, the UE could determine or identify the one or more activated beams/TCI states as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the one or more activation beam RSs or RS resources could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure. Here, the UE could determine or identify the value of m according to or based on: (i) a fixed value/rule in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M), (ii) network's configuration(s)/indication(s), e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M), and/or (iii) UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Additionally, the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The RS(s) or RS resource(s) or RS resource (configuration) index(es) of/for a current serving beam—denoted by current serving beam RS(s) or RS resource(s) or RS resource index(es)—for event(s), e.g., Event-1 and/or Event-2 as specified/defined herein in the present disclosure, evaluation(s) and/or determination(s) could be identified or determined according to one or more of:
Scheme-1: One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-2: One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

Candidate/new beam RS(s) or RS resource(s) or RS resource (configuration) index(es)—denoted by candidate/new beam RS(s) or RS resource(s) or RS resource (configuration) index(es)—for event(s), e.g., Event-1 and/or Event-3 as specified/defined herein in the present disclosure, evaluation(s) and/or determination(s) could be identified or determined according to a set of SS/PBCH block indexes provided by CSI-SSB-ResourceSet or a set of NZP CSI-RS resources provided by NZP-CSI-RS-ResourceSet (e.g., configured with ‘repetition’ or ‘repetition’ set to ‘enabled’ or ‘on’), wherein the candidate/new beam(s) set of SS/PBCH block indexes (CSI-SSB-ResourceSet) and/or NZP CSI-RS resources (NZP-CSI-RS-ResourceSet, e.g., configured with ‘repetition’ or ‘repetition’ set to ‘enabled’ or ‘on’) could be provided in or associated with higher layer parameter(s) CSI-ReportConfig, CSI-ResourceConfig associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

For evaluating, assessing or determining a given event (e.g., Event-1 as defined/specified herein in the present disclosure) and/or when/if a given event, e.g., Event-1 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the current serving beam RS(s) as SSB(s) according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the current serving beam RS(s) as NZP CSI-RS(s) or NZP CSI-RS resource(s) according to or following those specified or defined in Scheme-1.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2), and/or
   for example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1
In another example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’; when/if the higher layer parameter ‘currentBeamRStype’ is set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2, and/or when/if the higher layer parameter ‘currentBeamRStype’ is set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1. For this design example, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any set(s) of candidate/new RS index(es)—e.g., SSB index(es) or periodic CSI-RS resource configuration index(es)—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting, the UE could determine or identify the current serving beam RS(s) as SSB(s) for evaluating, assessing or determining the given event, e.g., Event-2, according to or following those specified or defined in Scheme-2, and/or when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of NZP CSI-RS resource or resource configuration index(es) as the candidate/new beam(s) set of RS index(es) for event(s) or event instance(s) evaluation(s) and/or beam measurement/reporting, the UE could determine or identify the current serving beam RS(s) as CSI-RS(s) for evaluating, assessing or determining the given event, e.g., Event-2, according to or following those specified or defined in Scheme-1. For this design example, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.

Furthermore, for evaluating, assessing or determining a given event (e.g., Event-2 as defined/specified herein in the present disclosure) and/or when/if a given event, e.g., Event-2 as defined/specified herein in the present disclosure, is enabled or provided or configured,
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ and set to ‘on’ or ‘enabled’ or ‘true’ or ‘SSB’ or ‘CSI-RS’, the UE could determine or identify whether the current serving beam RS(s) is SSB(s) or CSI-RS(s) for evaluating, assessing or determining the given event, e.g., Event-2, according to or based on the higher layer parameter ‘currentBeamRStype’ following those specified or defined herein in the present disclosure, regardless whether or not the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, candidate/new beam RS index(es)—e.g. in a resource set—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of candidate/new beam RS index(es)—e.g. a set of SSB index(es) or a set of periodic CSI-RS resource configuration index(es)—for event(s) or event instance(s) evaluation(s) and/or beam measurement/reporting, the UE could determine or identify whether the current serving beam RS(s) is SSB(s) or CSI-RS(s) for evaluating, assessing or determining the given event, e.g., Event-2, according to or based on whether the configured or provided candidate/new beam RS index(es) in the set is SSB index(es) or CSI-RS resource/resource configuration index(es) following those specified or defined herein in the present disclosure (e.g., those specified or defined in Scheme-1 and/or Scheme-2 in the present disclosure), regardless whether or not the aforementioned higher layer parameter ‘currentBeamRStype’ is present or provided or configured in the corresponding higher layer RRC signaling(s)/parameter(s), and/or regardless of the value(s) of the aforementioned higher layer parameter ‘currentBeamRStype’, if present/configured/provided.

For an activated TCI state—e.g., a joint/DL TCI state, a UE could determine or identify RS(s) or RS resource(s) or RS resource index(es) of/for the activated TCI state-denoted by activation beam RS(s) or RS resource(s) or RS resource indexe(s)—for event(s), e.g., Event-3 as specified/defined herein in the present disclosure, evaluation(s) and/or determination(s) according to one or more of:
Scheme-A: One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-B: One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For evaluating, assessing or determining a given event (e.g., Event-3 as defined/specified herein in the present disclosure) and/or when/if a given event, e.g., Event-3 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the activation beam RS(s) as SSB(s) according to or following those specified or defined in Scheme-B. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the activation beam RS(s) as NZP CSI-RS(s) or NZP CSI-RS resource(s) according to or following those specified or defined in Scheme-A.

Furthermore, in one example, for evaluating, assessing or determining given event(s)—e.g., Event-1 and/or Event-2 as defined/specified herein in the present disclosure—and/or when/if given event(s), e.g., Event-1 and/or Event-2 as defined/specified herein in the present disclosure, is/are enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in the indicated (joint/DL) TCI state (e.g., corresponding to the QCL RS), the UE could determine or identify the current serving beam RS(s)/RS resource(s)/RS resource configuration index(es) for evaluating, assessing or determining the given event(s), e.g., Event-1 and/or Event-2,
as a SSB as specified or defined in Scheme-2 according to or following those specified or defined herein in the present disclosure—for example, when/if the Scheme-2 is enabled by the network such that the candidate/new beam RS(s)/RS resource(s)/RS resource configuration(s) is configured or provided as SSB(s); for another example, when/if the Scheme-2 is enabled by the network such that the higher layer parameter e.g. currentBeamRStype is set to ‘SSB’;
as a NZP CSI-RS as specified or defined in Scheme-1 according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-1 is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-1 is enabled by the network such that the higher layer parameter e.g. currentBeamRStype is set to ‘CSI-RS’.

In another example, for evaluating, assessing or determining a given event—e.g., Event-3 as defined/specified herein in the present disclosure—and/or when/if a given event, e.g., Event-3 as defined/specified herein in the present disclosure, is enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in an activated (joint/DL) TCI state (e.g., corresponding to the QCL RS), the UE could determine or identify the activation beam RS(s)/RS resource(s)/RS resource configuration index(es) for evaluating, assessing or determining the given event, e.g., Event-3,
as a SSB as specified or defined in Scheme-B according to or following those specified or defined herein in the present disclosure—for example, when/if the Scheme-B is enabled by the network such that the candidate/new beam RS(s)/RS resource(s)/RS resource configuration(s) is configured or provided as SSB(s); for another example, when/if the Scheme-B is enabled by the network such that the higher layer parameter e.g. currentBeamRStype is set to ‘SSB’;
as a NZP CSI-RS as specified or defined in Scheme-A according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-A is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-A is enabled by the network such that the higher layer parameter e.g. currentBeamRStype is set to ‘CSI-RS’.

In one operation mode (Mode A),
Step-1: the UE could send the first message (also denoted by or referred to as a PN message/trigger or a UE-initiated transmission indication (UEITI) in the present disclosure), e.g., via a first UL channel comprising one or more PUCCH resources, wherein the one or more PUCCH resources could be periodic and/or semi-persistent (e.g., pre-configured by the network for transmitting the first message), and each of the one or more PUCCH resources (e.g., of format 0/1/2/3/4) could be from one or more PUCCH resource sets, e.g., configured/provided for transmitting/sending the first message—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for transmitting or sending the first message. According to those specified/defined herein in the present disclosure, the first message could request the network to transmit one or more RSs and/or configure one or more RS resources-denoted by UE-initiated (UEI) RS(s) or RS resource(s)—and/or one or more RS or RS resource sets-denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s) or to derive, determine, identify or obtain the corresponding CSI report(s), and/or request UL resource allocation and/or indication for transmitting second message(s)
also denoted by or referred to as UEI report content(s)/quantity(s) in the present disclosure. Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the first message. For instance, the information/configuration(s)/setting(s) could be provided or configured or indicated or comprised or contained or included in a higher layer RRC parameter/configuration denoted by firstMessage-Config comprising one or more of:
   firstMessageId: used to modify a first message configuration and to indicate, in LogicalChannelConfig, the first message configuration to which a logical channel is mapped and to indicate the first message configuration for which a first message (i.e., the first PUCCH resource) is used
   fm-ProhibitTimer: a timer for first message transmission(s) on PUCCH. Value is in symbol, slot, ms etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1ms, value ms2 corresponds to 2 ms, and so on. If fm-ProhibitTimer is absent, the UE could apply the value 0.
   fm-TransMax: a maximum number of first message transmissions. Value n4 corresponds to 4, value n8 corresponds to 8, and so on.
   periodicityAndOffset: first message periodicity and offset in number of symbols or slots. The periodicity(s) could be configured or provided depending on the chosen subcarrier spacing.
   Phy-PriorityIndex: indicate whether this first message resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the first message. The actual PUCCH-Resource is configured in PUCCH-Config of the same UL BWP and serving cell as this FirstMessageResourceConfig. The network could configure a PUCCH-Resource of PUCCH-format0 or PUCCH-format1 or PUCCH-format3 or PUCCH-format4.
Step-2: after the UE has transmitted the first message, the UE could expect to receive from the network a (downlink/uplink) DCI in response to the first message, within a time window (e.g., no earlier than A1 symbol(s)/slot(s) and/or no later than A2 symbol(s)/slot(s)) starting from the first or last symbol/slot/etc. of the transmission of the first message. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.), A1 and/or A2. In addition, the UE could indicate to the network, e.g., in form of a UE's capability via a UE's capability signaling, whether or not the UE could expect to receive from the network the (downlink/uplink) DCI in response to the first message transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the first message. The (downlink/uplink) DCI in response to the first message could comprise one or more of the following components:
   Component-1: a one-bit indicator with ‘1’ (or ‘0’) indicating acknowledgement (ACK) for the first message and ‘0’ (or ‘1’) indicating non-ACK (NACK) for the first message
   Component-2: a time gap/duration (e.g., in number of symbols/slots/etc.)
   Component-3: a priority order or value for the first message and/or second message(s) associated/specific to the first message as defined/specified herein in the present disclosure
   Component-4: a time offset (e.g., in number of symbols/slots/etc.)
   Component-5: resource allocation and/or indication for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource allocation and/or indication for the second UL channel could comprise or correspond/refer to one or more of the following components, and/or could be determined according to one or more of the following components:
   Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k=[log₂K]. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the second message(s) in/via the second UL channel.
   Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the second message(s) in/via the second UL channel.
   Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-5f: one or more CSI reporting configuration/setting IDs/indexes, wherein a CSI reporting setting/configuration is provided by CSI-ReportConfig.
   Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-5h: a starting symbol/slot/etc. for the second UL channel
   Component-5i: an ending symbol/slot/etc. for the second UL channel
   Component-5j: a time duration/length (e.g., in form/terms/number of symbols/slot/etc.), within which the resources could be allocated/indicated for the second UL channel
   Component-5k: a number of resources allocated/indicated for the second UL channel
   Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k=[log₂K]. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the second message(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the second message(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the second message(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the second message(s) associated/specific to the first message transmitted or sent via/in the first UL channel as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type 1 and/or Type2, dynamically granted/scheduled by the network for sending the second message(s) including DG PUSCH). In this step, the UE could expect to receive the (downlink/uplink) DCI in response to the transmission of the first message comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the second message(s) associated/specific to the first message sent/transmitted in/via the first UL channel (in Step-1) on or over the determined or identified resource(s) for the second UL channel. For this design example—e.g., the (downlink/uplink) DCI in response to the first message transmission could indicate, provide or comprise component(s) related to dynamic scheduling of resource(s) such as Component-5g, Component-5l, Component-6g and Component-6l, the UE could have sent or transmitted the (same) first message max_FM times or instances to indicate a potential transmission of the second message(s) associated/specific to the first message before a timer expires—but without transmitting or sending the actual second message(s) associated/specific to the first message, and/or though the UE may expect to receive from the network a (downlink/uplink) DCI in response to the first message according to those specified herein in the present disclosure, the UE does not receive the DCI (e.g., indicating an ACK for the first message) within the time window, wherein the value(s) of max_FM and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel.

The (downlink/uplink) DCI (in Step-2) in response to the transmission of the first message in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the first message transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a first message or a transmission of a first message or a configuration of first message or an order/index of a (transmission of) first message, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a first message in Step-1; upon detection of reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the first message in Step-1 and/or any other identification information related to the UE. The UE could then identify or determine the resource(s) based on the identified or determined set of components following those specified herein in the present disclosure to use for transmitting or sending the second UL channel carrying or conveying the second message(s) associated/specific to the first message transmitted or sent in Step-1 via/in the first UL channel.

In one operation mode (Mode B),
Step-1: the UE could send the first message, e.g., via a first UL channel comprising one or more PUCCH resources, wherein the one or more PUCCH resources could be periodic and/or semi-persistent (e.g., pre-configured by the network for transmitting the first message), and each of the one or more PUCCH resources (e.g., of format 0/1/2/3/4) could be from one or more PUCCH resource sets, e.g., configured/provided for transmitting/sending the first message—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for transmitting or sending the first message. Here, the first message could request the network to transmit one or more RSs and/or configure one or more RS resources-denoted by UE-initiated (UEI) RS(s) or RS resource(s)—and/or one or more RS or RS resource sets-denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s) or to derive, determine, identify or obtain the corresponding CSI report(s), and/or indicate a potential transmission of the second message(s) associated/specific to the first message, and/or request UL resource allocation and/or indication for a second UL channel that could carry or convey the second message(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the first message. For instance, the information/configuration(s)/setting(s) could be provided or configured or indicated or comprised or contained or included in a higher layer RRC parameter/configuration denoted by FM-Config comprising one or more of:
   firstMessageId: used to modify a first message configuration and to indicate, in LogicalChannelConfig, the first message configuration to which a logical channel is mapped and to indicate the first message configuration for which a first message resource (i.e., the first PUCCH resource) is used
   fm-ProhibitTimer: a timer for first message transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1ms, value ms2 corresponds to 2 ms, and so on. If fm-ProhibitTimer is absent, the UE could apply the value 0.
   fm-TransMax: a maximum number of first message transmissions. Value n4 corresponds to 4, value n8 corresponds to 8, and so on.
   periodicityAndOffset: first message periodicity and offset in number of symbols or slots. The periodicity(s) could be configured or provided depending on the chosen subcarrier spacing.
   Phy-PriorityIndex: indicate whether this first message resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the first message. The actual PUCCH-Resource is configured in PUCCH-Config of the same UL BWP and serving cell as this FirstMessageResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the second message(s) associated/specific to the first message transmitted or sent via/in the first UL channel as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2); the UE could determine or identify the resource(s) for the second UL channel according to one or more of:
   In one example, the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than B1 symbol(s)/slot(s) and/or no later than B2 symbol(s)/slot(s)) after the first or last symbol/slot/etc. of the transmission of the first message. The value(s) of the time period/window/duration t1, B1 and/or B2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, B1 and/or B2 (e.g., in form/terms/number of slots/symbols/etc.): for example, the value(s) of t1, B1 and/or B2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, B2 and/or B1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel, regardless of whether or not a (downlink/uplink) DCI format in response to the first message is received, the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than B1 symbol(s)/slot(s) and/or no later than B2 symbol(s)/slot(s)) after the first or last symbol/slot/etc. of the transmission of the first message. The value(s) of the time period/window/duration t1, B1 and/or B2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, B1 and/or B2 (e.g., in form/terms/number of slots/symbols/etc.): for example, the value(s) of t1, B1 and/or B2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, B1 and/or B2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C),
Step-1: the UE could send the first message, e.g., via a first UL channel comprising one or more PUCCH resources, wherein the one or more PUCCH resources could be periodic and/or semi-persistent (e.g., pre-configured by the network for transmitting the first message), and each of the one or more PUCCH resources (e.g., of format 0/1/2/3/4) could be from one or more PUCCH resource sets, e.g., configured/provided for transmitting/sending the first message—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for transmitting or sending the first message. Here, the first message could request the network to transmit one or more RSs and/or configure one or more RS resources-denoted by UE-initiated (UEI) RS(s) or RS resource(s)—and/or one or more RS or RS resource sets-denoted by UEI RS or RS resource set(s)—for the UE to monitor, track, measure or assess e.g. their radio link qualities and/or L1 beam qualities including L1-RSRPs/L1-SINRs or to perform/conduct necessary synchronization(s) or to derive, determine, identify or obtain the corresponding CSI report(s), and/or indicate a potential transmission of the second message(s) associated/specific to the first message, and/or request UL resource allocation and/or indication for a second UL channel that could carry or convey the second message(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the first message. For instance, the information/configuration(s)/setting(s) could be provided or configured or indicated or comprised or contained or included in a higher layer RRC parameter/configuration denoted by FM-Config comprising one or more of:
   firstMessageId: used to modify a first message configuration and to indicate, in LogicalChannelConfig, the first message configuration to which a logical channel is mapped and to indicate the first message configuration for which a first message resource (i.e., the first PUCCH resource) is used
   fm-ProhibitTimer: a timer for first message transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1ms, value ms2 corresponds to 2 ms, and so on. If fm-ProhibitTimer is absent, the UE could apply the value 0.
   fm-TransMax: a maximum number of first message transmissions. Value n4 corresponds to 4, value n8 corresponds to 8, and so on.
   periodicityAndOffset: first message periodicity and offset in number of symbols or slots. The periodicity(s) could be configured or provided depending on the chosen subcarrier spacing.
   Phy-PriorityIndex: indicate whether this first message resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the first message. The actual PUCCH-Resource is configured in PUCCH-Config of the same UL BWP and serving cell as this FirstMessageResourceConfig. The network could configure a PUCCH-Resource of PUCCH-format0 or PUCCH-format1 or PUCCH-format3 or PUCCH-format4.
Step-2: after the UE has transmitted the first message, the UE could expect to receive from the network a (downlink/uplink) DCI in response to the first message, within a time window (or no earlier than C1 symbol(s)/slot(s) and/or no later than C2 symbol(s)/slot(s)) starting from the first or last symbol/slot/etc. of the transmission of the first message. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window, C1 and/or C2. In addition, the UE could indicate to the network, e.g., in form of a UE's capability via a UE's capability signaling, whether or not the UE could expect to receive from the network the (downlink/uplink) DCI in response to the first message transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the first message. The (downlink/uplink) DCI in response to the first message could comprise one or more of the following components:
   Component-1: a one-bit indicator with ‘1’ (or ‘0’) indicating acknowledgement (ACK) for the first message and ‘0’ (or ‘1’) indicating non-ACK (NACK) for the first message
   Component-2: a time gap/duration (e.g., in number of symbols/slots/etc.)
   Component-3: a priority order or value for the first message and/or the second message(s) associated/specific to the first message as defined/specified herein in the present disclosure
   Component-4: a time offset (e.g., in number of symbols/slots/etc.)
   Component-5: resource allocation and/or indication for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k=[log₂K]. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. to, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the second message(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the second message(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
   Component-6: indication of resource(s) not used/available/applicable for the second UL channel for transmitting or sending the second message(s) associated/specific to the first message as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type1 and/or Type2, dynamically granted/scheduled by the network for sending the second message(s) including DG PUSCH); the resource(s) not used/available/applicable for the second UL channel could be in form of one or more of the following components, and/or the resource(s) not used/available/applicable for the second UL channel could be determined according to one or more of the components:
      Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k=[log₂K]. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the second message(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the first message sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the first message, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the second message(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the second message(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the second message(s) associated/specific to the first message transmitted or sent via/in the first UL channel as defined/specified herein in the present disclosure, wherein the second UL channel could comprise one or more periodic/semi-persistent PUCCH resources (e.g., pre-configured by the network for sending the second message(s)) and/or one or more PUSCH resources (e.g., pre-configured by the network for sending the second message(s) including CG PUSCH of Type 1 and/or Type2, dynamically granted/scheduled by the network for sending the second message(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the first message in Step-1, the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message. The value(s) of the time period/window/duration t1, D1 and/or D2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D1 and/or D2 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the first message in Step-1, and/or when/if after the UE has transmitted or sent the first message via the first UL channel in Step-1 but does not receive the (downlink/uplink) DCI in response to the first message as specified or discussed in Step-2 a first time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message, and/or when/if after the UE has transmitted or sent the (same) first message max_FM times/instances—each separated by a time gap-within a second time period/window/duration (e.g., denoted by t2 in terms/form/number of symbols/slots/etc., or no earlier than E1 symbol(s)/slot(s) and/or no later than E2 symbol(s)/slot(s)) but does not receive the (downlink/uplink) DCI in response to the last transmission time/instance of the (same) first message, the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a third time period/window/duration (e.g., denoted by t3 in terms/form/number of symbols/slots/etc., or no earlier than F1 symbol(s)/slot(s) and/or no later than F2 symbol(s)/slot(s)) after the first or last symbol/slot/etc. of the transmission of the first message. The value(s) of the max_FM, the time gap, the first, second and/or third time period(s)/window(s)/duration(s) t1, t2 and/or t3, D1, D2, E1, E2, F1 and/or F2 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.), D1, D2, E1, E2, F1 and/or F2: for example, the value(s) of t1, t2 and/or t3, D1, D2, E1, E2, F1 and/or F2 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3, D1, D2, E1, E2, F1 and/or F2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the first message comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the first message comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the first message comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the first message comprising one or more of the components including Component-1 (e.g., an ACK for the first message), Component-2, Component-3 and/or Component-4 and/or Component-7 (i.e., except Component-5 and Component-6). For this design example, the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t2 in terms/form/number of symbols/slots/etc., or no earlier than E1 symbol(s)/slot(s) and/or no later than E2 symbol(s)/slot(s)) after the first or last symbol/slot/etc. of the transmission of the first message and/or after the first or last symbol/slot/etc. of the reception of the (downlink/uplink) DCI format in response to the transmission of the first message. The value(s) of the time period/window/duration t2, E1 and/or E2 could be determined according to: (i) fixed value(s) in system specification(s) and/or per RRC configuration, e.g., t2-0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2, E1 and/or E2 could be determined according to the time gap/duration provided/indicated in Component-2 and/or the time offset provided/indicated in Component-4 as/in part of the (downlink/uplink) DCI format in response to the first message; for (iii), i.e., for the UE to autonomously determine or select the value(s) of the time period/window/duration t2, E1 and/or E2 (e.g., in form/terms/number of slots/symbols/etc.): for example, the value(s) of t2, E1 and/or E2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2, E1 and/or E2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the second message(s) associated/specific to the first message sent/transmitted in/via the first UL channel (in Step-1) on or over the determined or identified resource(s) for the second UL channel. For this design example—e.g., the (downlink/uplink) DCI in response to the first message transmission does not indicate, provide or comprise component(s) related to dynamic scheduling of resource(s) such as Component-5g, Component-5l, Component-6g and Component-6l, the UE could have sent or transmitted the (same) first message max_FM times or instances to indicate a potential transmission of the second message(s) associated/specific to the first message before a timer expires—but without transmitting or sending the actual second message(s) associated/specific to the first message, and/or though the UE may expect to receive from the network a (downlink/uplink) DCI in response to the first message according to those specified herein in the present disclosure, the UE does not receive the DCI (e.g., indicating an ACK for the first message) within the time window, wherein the value(s) of max_FM and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type 1 and/or Type2) for sending the second message(s) via/in the second UL channel.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the second message(s) associated/specific to the first message sent/transmitted in/via the first UL channel (in Step-1) on or over the determined or identified resource(s) for the second UL channel. For this design example—e.g., the (downlink/uplink) DCI in response to the first message transmission could indicate, provide or comprise component(s) related to dynamic scheduling of resource(s) such as Component-5g, Component-5l, Component-6g and Component-6l, the UE could have sent or transmitted the (same) first message max_FM times or instances to indicate a potential transmission of the second message(s) associated/specific to the first message before a timer expires—but without transmitting or sending the actual second message(s) associated/specific to the first message, and/or though the UE may expect to receive from the network a (downlink/uplink) DCI in response to the first message according to those specified herein in the present disclosure, the UE does not receive the DCI (e.g., indicating an ACK for the first message) within the time window, wherein the value(s) of max_FM and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel. For this design example, when/if the (downlink/uplink) DCI in response to the first message is received p1 (in number of slots/symbols/etc.) earlier in time than the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the second message(s) associated/specific to the first message sent/transmitted in/via the first UL channel (in Step-1) on or over the determined or identified resource(s) for the second UL channel. The value(s) of p1, p2, t1 and/or the time period/window/duration, D1 and/or D2 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel. For this design example, when/if the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message is q1 (in number of slots/symbols/etc.) earlier in time than the reception of the (downlink/uplink) DCI in response to the first message, and/or when/if the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message. The value(s) of the time period/window/duration t1, D1 and/or D2 could be determined according to: (i) fixed value(s) in system specification(s) and/or per RRC configuration, e.g., t1=0symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D2 and/or D1 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the first message comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel. For this design example, regardless of how/when the periodic/semi-persistent PUCCH resource(s) and/or the PUSCH resource(s) such as CG PUSCH of Type1 and/or Type2 is (pre-)configured by the network for transmitting or sending the second message(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the second message(s) associated/specific to the first message sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel, regardless of whether or not a (downlink/uplink) DCI format in response to the first message is received, the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message. The value(s) of the time period/window/duration t1, D1 and/or D2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D1 and/or D2 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the second message(s) via/in the second UL channel and/or the one or more PUSCH resources (e.g., pre-configured by the network including CG PUSCH of Type1 and/or Type2) for sending the second message(s) via/in the second UL channel and/or the UE receives a (downlink/uplink) DCI in response to the first message comprising at least an ACK (e.g., in Component-1) for the transmission of the first message, regardless of whether or not the (downlink/uplink) DCI format in response to the first message comprises or provides or indicates component(s)—e.g., Component-5 and/or Component-6 as defined/specified herein in the present disclosure—that provides or comprises or indicates resource allocation and/or indication for the second UL channel to carry or convey the second message(s) associated/specific to the first message, the UE could transmit or send to the network-via/in the second UL channel—the second message(s) associated/specific to the first message using or on or over the most recent and/or available UL resource(s) including the periodic/semi-persistent PUCCH resource(s) pre-configured by the network for sending the second message(s) and/or the PUSCH resource(s) pre-configured by the network for sending the second message(s) such as CG PUSCH of Type1 and/or Type2 a time period/window/duration (e.g., denoted by t1 in terms/form/number of symbols/slots/etc., or no earlier than D1 symbol(s)/slot(s) and/or no later than D2 symbol(s)/slot(s)) after the first or last symbol/slot/etc. of the transmission of the first message and/or after the first or last symbol/slot/etc. of the reception of the (downlink/uplink) DCI format in response to the transmission of the first message. The value(s) of the time period/window/duration t1, D1 and/or D2 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1, D2 and/or D1 (e.g., in form/terms/number of slots/symbols/etc.): for example, the value(s) of t1, D1 and/or D2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1, D1 and/or D2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the first message in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the first message transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a first message or a transmission of a first message or a configuration of first message or an order/index of a (transmission of) first message, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a first message in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the first message in Step-1 and/or any other identification information related to the UE. The UE could then identify or determine the resource(s) based on the identified or determined set of components following those specified herein in the present disclosure to use for transmitting or sending the second UL channel carrying or conveying the second message(s) associated/specific to the first message transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam operations including UEI measurement RS(s) transmission(s), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam operations including UEI measurement RS(s) transmission(s); in this case, the UE could indicate to the network in their capability signaling(s) one or more of:
Support of Mode A and therefore the corresponding operations
Support of Mode B and therefore the corresponding operations
Support of Mode C and therefore the corresponding operations
That is, a UE's capability or capability signaling could comprise one or more components each indicating support of:
{Mode A}
{Mode B}
{Mode C}
{Mode A, Mode B}
{Mode A, Mode C}
{Mode B, Mode C}

For Mode A, Mode B and/or Mode C as specified/defined herein in the present disclosure, a first message could correspond to or could be equivalent to or could be replaced by/with or could be used in an exchangeable manner with transmission of a first message, a first message transmission, a first message transmission occasion, a PUCCH resource of the first UL channel, a first message transmission (occasion) via/in/by a PUCCH resource of the first UL channel and/or etc. throughout the present disclosure; and/or, a second message could correspond to or could be equivalent to or could be replaced by/with or could be used in an exchangeable manner with transmission of a second message, a second message transmission, a second message transmission occasion, a PUSCH resource of the second UL channel, a second message transmission (occasion) via/in/by a PUSCH resource of the second UL channel and/or etc. throughout the present disclosure. For instance, a second message associated/specific to a first message could be equivalent to a PUSCH resource of the second UL channel that carries or conveys the second message associated/specific to a PUCCH resource of the first UL channel that carries or conveys the first message, and/or a/the second message transmission occasion of a PUSCH resource of the second UL channel associated/specific to a/the first message transmission occasion of a PUCCH resource of the first UL channel.

According to or following those specified herein in the present disclosure,
For Event-1 as specified/defined herein in the present disclosure, when/if (higher layer(s) of) a UE has determined or identified that a first Event-1 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of the current serving beam RS/RS resource as specified/defined herein in the present disclosure, and (higher layer(s) of) the UE has determined or identified that a second Event-1 instance is associated/specific to the (same) new/candidate beam RS/RS resource such that the UE could determine or identify that the candidate/new beam RS/RS resource has a beam quality/metric (e.g., a measured L1-RSRP/L1-SINR) the threshold value greater than or equal to the beam quality(s)/metric(s)—e.g., measured L1-RSRP(s)/L1-SINR(s)—of the current serving beam RS/RS resource, the first and second Event-1 instances could be associated/specific to the (same) new/candidate beam RS/RS resource.
For Event-2 as specified/defined herein in the present disclosure, when/if (higher layer(s) of) a UE has determined or identified that a first Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, and (higher layer(s) of) the UE has determined or identified that a second Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, the first and second Event-2 instances could be associated/specific to the current beam RS/RS resource.
For Event-3 as specified/defined herein in the present disclosure, (higher layer(s) of) a UE could determine or identify that a first Event-3 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a first activated beam/TCI state or a first activation beam RS/RS resource as specified/defined herein in the present disclosure; furthermore, the UE could determine or identify the first activated beam/TCI state as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the first activation beam RS or RS resource could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure, and (higher layer(s) of) the UE could determine or identify that a second Event-3 instance is associated/specific to the new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a second activated beam/TCI state or a second activation beam RS/RS resource as specified/defined herein in the present disclosure; furthermore, the UE could determine or identify the second activated beam/TCI state as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the second activation beam RS or RS resource could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure. In this case, the UE could determine or identify the first activation beam RS/RS resource (and therefore, the corresponding first activated beam/TCI state and the measurement result(s) including beam quality(s)/metric(s) such as L1-RSRP(s)/L1-SINR(s)) and the second activation beam RS/RS resource (and therefore, the corresponding second activated beam/TCI state and the measurement result(s) including beam quality(s)/metric(s) such as L1-RSRP(s)/L1-SINR(s)) from two separate MOs according to or following those specified herein in the present disclosure.
   When/if the first activation beam RS/RS resource (and the corresponding first activated beam/TCI state) is the same as or identical to the second activation beam RS/RS resource (and the corresponding second activated beam/TCI state), the UE could determine or identify or it could be said that the first and second Event-3 instances could be associated/specific to (a pair of) the (same) new/candidate beam RS/RS resource and the (same) activation beam RS/RS resource (or equivalently, the (same) activated beam/TCI state).
   When/if the first activation beam RS/RS resource (and the corresponding first activated beam/TCI state) is different or separate from the second activation beam RS/RS resource (and the corresponding second activated beam/TCI state), the UE could determine or identify or it could be said that the first and second Event-3 instances could be associated/specific (only) to the (same) new/candidate beam RS/RS resource.

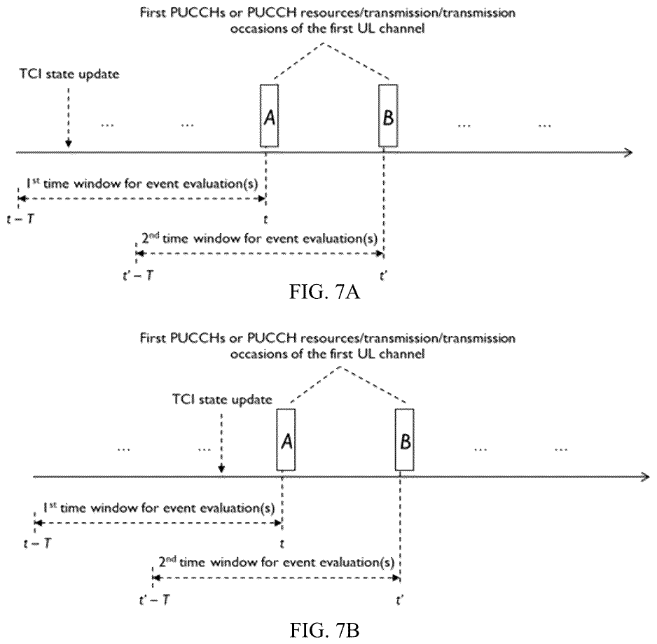

FIGS. 7A and 7B illustrate an example timeline 710 and 720 for time window determination according to embodiments of the present disclosure. For example, timeline 710 and 720 can be followed by the UE 116 of FIG. 3. This example is for illustration only and other embodiments can be used without departing from the scope of the present disclosure.

With reference to FIG. 7A, the TCI state update within the first time window PUCCH A is not transmitted. No TCI state update within the second time window, PUCCH B can be transmitted, if event conditions are satisfied. With reference to FIG. 7B, TCI state update within the first and second time windows, both PUCCH A and PUCCH B are not transmitted.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   /specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. One conceptual example of the above described design example/procedure is presented in FIGS. 7A and 7B.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′-1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
   For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window

The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Furthermore, the reference beam RS or RS resource could be derived from an activated TCI state with the Q-th best beam quality e.g. L1-RSRP among all the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)
The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window

The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
the UE could transmit or trigger or initiate a transmission of the PN message/trigger over/on/via/in the PUCCH resource or transmission or transmission occasion of the first UL channel. Here, T′ could be less than or equal to T, and the time duration or length of the time window is (T−T′) or (T−T′-1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. Furthermore, the reference beam RS or RS resource could be derived from an activated TCI state with the Q-th best beam quality e.g. L1-RSRP among all the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T−T_proc (e.g., in form of a slot or a symbol, i.e., slot or symbol t−T−T_proc or the (t−T−T_proc)-th slot or symbol) and ending at time t−T_proc is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Here, T_proc could be in slot, symbol, etc., which could represent processing time of PUCCH transmission(s) of the first UL channel including UCI bit(s) preparation and etc. The UE could determine or identify value(s) of T_proc according to or based on one or more of: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. When/if the UE could not determine or identify or declare an/the event within a first time window starting from time t−T−T_proc and ending at time t−T_proc according to or following those specified herein in the present disclosure: for example, when/if the UE could not identify or determine, within the first time window starting from time t−T−T_proc and ending at time t−T_proc, any candidate/new beam RS(s) or RS resource(s) that satisfies or achieves the event condition(s)—e.g., to satisfy the event condition(s) for a candidate/new beam RS or RS resource, the number/counting of event instance(s) within the first time window should be greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
and/or when/if one or more of the following conditions are achieved or satisfied:
The UE does not receive a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE does not receive a (unified) TCI state(s) activation/deactivation MAC CE within the first time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE does not receive any form/format of a beam failure recover response (BFRR) within the first time window
The UE or higher layer(s) of the UE does not start (or starts) a prohibit timer as defined/specified herein in the present disclosure within the first time window, and/or the prohibit timer expires (or does not expire) within the first time window
For Mode-A/Mode-B, the UE does not receive a DCI in Step-2 in response to the transmission of the PN message/trigger in Step-1 within the first time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE does not receive triggering of aperiodic or semi-persistent CSI measurement and/or reporting (e.g., via a CSI request field in a triggering DCI) within the first time window
The UE does not receive activation of semi-persistent CSI measurement and/or reporting (e.g., via SP CSI measurement and/or reporting activation MAC CE(s)) within the first time window;
and for another example, when/if one or more of the following conditions are achieved or satisfied:
The UE receives a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE receives a (unified) TCI state(s) activation/deactivation MAC CE within the first time window
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE receives a beam failure recover response (BFRR) within the first time window
The UE or higher layer(s) of the UE starts (or does not start) a prohibit timer as defined/specified herein in the present disclosure within the first time window, and/or the prohibit timer does not expire (or expires) within the first time window
For Mode-A/Mode-B, the UE receives a DCI in Step-2 in response to the transmission of the PN message/trigger in Step-1 within the first time window
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE receives triggering of aperiodic or semi-persistent CSI measurement and/or reporting (e.g., via a CSI request field in a triggering DCI) within the first time window
The UE receives activation of semi-persistent CSI measurement and/or reporting (e.g., via SP CSI measurement and/or reporting activation MAC CE(s)) within the first time window,
the UE could determine or identify or declare an/the event when/if the number/counting of event instance(s) within a second time window starting from time t−T−T_proc-t_offset (e.g., in form of a slot or a symbol, i.e., slot or symbol t−T−T_proc-t_offset or the (t−T−T_proc-t_offset)-th slot or symbol) and ending at time t−T_proc-t_offset is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the second time window
The UE receives a TCI state update within the second time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the second time window
The UE does not receive a (unified) TCI state(s) activation/deactivation MAC CE within the second time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the second time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the second time window, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the second time window, wherein the UE could determine or identify the value of m according to or following those specified herein in the present disclosure
The UE does not receive any form/format of a beam failure recover response (BFRR) within the second time window
The UE or higher layer(s) of the UE does not start (or starts) a prohibit timer as defined/specified herein in the present disclosure within the second time window, and/or the prohibit timer expires (or does not expire) within the second time window
For Mode-A/Mode-B, the UE does not receive a DCI in Step-2 in response to the transmission of the PN message/trigger in Step-1 within the second time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the second time window
The UE does not receive triggering of aperiodic or semi-persistent CSI measurement and/or reporting (e.g., via a CSI request field in a triggering DCI) within the second time window
The UE does not receive activation of semi-persistent CSI measurement and/or reporting (e.g., via SP CSI measurement and/or reporting activation MAC CE(s)) within the second time window.

After the determination or identification or declaration of an/the event according to the second time window, the UE could transmit or trigger or initiate a transmission of the PN message/trigger over/on/via/in the PUCCH resource or transmission or transmission occasion of the first UL channel at time t. The UE could determine or identify value(s) of t_offset (e.g., in form/terms of symbol(s)/slot(s)/etc.) according to or based on: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. For example, candidate value(s) of t_offset could be {1, 2, . . . , 10, 20, 40, . . . } slot(s)/symbol(s)/ms/etc. For another example, t_offset could correspond to one or more of:
Periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
Periodicity of an event evaluation or event evaluation instance for determining an event instance according to or following those specified herein in the present disclosure
Periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min {periodicity of a first MO, periodicity of a second MO}
max {periodicity of a first MO, periodicity of a second MO}
max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). According to or following those specified herein in the present disclosure:
When/if the UE could determine or identify or declare an/the event within a k-th time window starting from time t−T−T_proc−k×t_offset and ending at time t−T_proc−k×t_offset according to or following those specified herein in the present disclosure, the UE could transmit or trigger or initiate a transmission of the PN message/trigger over/on/via/in the PUCCH resource or transmission or transmission occasion of the first UL channel at time t, and/or
When/if the UE could determine or identify or declare an/the event within a k-th time window starting from time t−T−T_proc-k×t_offset and ending at time t−T_proc−k×t_offset according to or following those specified herein in the present disclosure, the UE may not check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure, and/or.
When/if the UE could not determine or identify or declare an/the event within a k-th time window starting from time t−T−T_proc−k×t_offset and ending at time t−T_proc−k×t_offset according to or following those specified herein in the present disclosure, the UE could further check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure.

In this case, k∈{0, . . . , Kmax}, wherein the UE could determine or identify vaue(s) of k and/or Kmax according to or based on: 1) fixed value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.
In one example, the starting time t−T−T_proc−(Kmax+1)×t_offset of the Kmax-th time window could be no earlier than t−2×T−T_proc, and/or the ending time t−T_proc−(Kmax+1)×t_offset of the Kmax-th time window could be no earlier than t−T−T_proc.
In another example, the ending time t−T_proc−(Kmax+1)×t_offset of the Kmax-th time window could be no earlier than t−T_pucch-T_proc, wherein T_pucch (e.g., in form/terms of symbol(s)/slot(s)/etc.) represents the periodicity of/for the PUCCH resource(s).

The (second) time window(s) here can also be referred to as sliding time window(s) with a time offset t_offset.

In another example, when/if a UE has determined or identified or declared an event instance wherein:
for Event-1, the event instance could be associated/specific to at least one (same) new/candidate beam RS/RS resource according to or following those specified herein in the present disclosure
for Event-2, the event instance could be associated/specific to the current beam RS/RS resource according to or following those specified herein in the present disclosure
for Event-3, the event instance could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
(higher layer(s) of) the UE could start a time window/timer;
according to or following those specified herein in the present disclosure, when/if (higher layer(s) of) the UE has determined or identified the aforementioned event instance before end of the time window and/or within the time window (e.g., before the last symbol/slot/etc. of the time window, wherein duration/length of the time window could be higher layer configured) and/or before the timer expires, (higher layer(s) of) the UE could increment an event instance count/counting for or of or specific to the new beam RS or RS resource by one;
before end of the time window and/or within the time window (e.g., before the last symbol/slot/etc. of the time window, wherein duration/length of the time window could be higher layer configured) and/or before the timer expires, when/if (higher layer(s) of) the UE has determined or identified that the number of the event instance(s) and/or the event instance count(s)/counting(s) is greater than or equal to maxCount (e.g., higher layer configured), (higher layer(s) of) the UE could determine or identify or declare a potential/candidate event occurrence.

For Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could first determine or identify a time duration starting from time t−T_du-T_proc (e.g., in form of a slot or a symbol, i.e., slot or symbol t−T_du-T_proc or the (t−T_du-T_proc)-th slot or symbol) and ending at time t−T_proc—e.g., the time duration here could be associated/specific/corresponding to the PUCCH resource or transmission or transmission occasion at time t. The UE (e.g., higher layer(s) of the UE) could determine or identify or declare an/the event when/if (higher layer(s) of) the UE could determine or identify or declare at least one potential/candidate event occurrence (or one or more potential/candidate event occurrences) according to or following those specified or described herein in the present disclosure within the aforementioned time duration associated/specific/corresponding to the PUCCH resource or transmission or transmission occasion at time t—for instance,
the start of the time window(s)/timer(s) used to determine or identify or declare the at least one (or the one or more) potential/candidate event occurrence(s) could be after or no earlier than the start of the time duration; and/or
the end of the time window(s) used to determine or identify or declare the at least one (or the one or more) potential/candidate event occurrence(s) could be before or no later than the end of the time duration, or the timer(s) used to determine or identify or declare the at least one (or the one or more) potential/candidate event occurrence(s) may not expire or may not be expired before or no later than the end of the time duration; and/or
the time window(s) used to determine or identify or declare the at least one (or the one or more) potential/candidate event occurrence(s) could be within the time duration
and/or when/if one or more of the following conditions are achieved or satisfied:
The UE does not receive a TCI state update within the time duration
The UE receives a TCI state update within the time duration, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time duration
The UE does not receive a (unified) TCI state(s) activation/deactivation MAC CE within the time duration
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time duration
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time duration, wherein the UE could determine or identify the value of m according to or following those specified herein in the present disclosure
The UE does not receive a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time duration, wherein the UE could determine or identify the value of m according to or following those specified herein in the present disclosure
The UE does not receive any form/format of a beam failure recover response (BFRR) within the time duration
The UE or higher layer(s) of the UE does not start (or starts) a prohibit timer as defined/specified herein in the present disclosure within the time duration, and/or the prohibit timer expires (or does not expire) within the time duration
For Mode-A/Mode-B, the UE does not receive a DCI in Step-2 in response to the transmission of the PN message/trigger in Step-1 within the time duration
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time duration
The UE does not receive triggering of aperiodic or semi-persistent CSI measurement and/or reporting (e.g., via a CSI request field in a triggering DCI) within the time duration
The UE does not receive activation of semi-persistent CSI measurement and/or reporting (e.g., via SP CSI measurement and/or reporting activation MAC CE(s)) within the time duration.

After the determination or identification or declaration of an/the event according to the time duration, the UE could transmit or trigger or initiate a transmission of the PN message/trigger over/on/via/in the PUCCH resource or transmission or transmission occasion of the first UL channel at time t. Here, the UE could determine or identify value(s) of the time duration and/or T_du according to or following: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
For example, T_du could correspond to or higher layer configured as T_pucch, wherein T_pucch represents the periodicity of the PUCCH resource(s)/transmission(s)/transmission occasion(s) of the first UL channel.
For another example, T_du could correspond to or higher layer configured as 0 or T_pucch or a value (e.g., in form/terms of number of symbol(s)/slot(s)/ms/etc.) in the range of [0, T_pucch], wherein T_pucch represents the periodicity of the PUCCH resource(s)/transmission(s)/transmission occasion(s) of the first UL channel.
For another example, T_du could correspond to or higher layer configured as the periodicity of an event evaluation or event evaluation instance for determining an event instance according to or following those specified herein in the present disclosure
For another example, T_du could correspond to or higher layer configured as the periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
For another example, T_du could correspond to or higher layer configured as min {periodicity of a first MO, periodicity of a second MO}
For another example, T_du could correspond to or higher layer configured as max {periodicity of a first MO, periodicity of a second MO}
For another example, T_du could correspond to or higher layer configured as max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Furthermore, according to or following those specified herein in the present disclosure, i.e., for the operation(s) in Mode-A, Mode-B and/or Mode-C as specified/defined herein in the present disclosure, the UE could send or transmit to the network beam report(s)—e.g., via/in/by the (CG/DG) PUSCH resource(s) of the second UL channel-associated/specific to the transmission or triggering or initiation of the transmission of the PN message/trigger over/on/via/in the PUCCH resource or transmission or transmission occasion of the first UL channel at time t. In this case, the UE could determine or identify report content(s)/quantity(s) including at least SSBRI(s)/CRI(s) and/or L1-RSRP(s)/L1-SINR(s) of the beam report(s) based on or according to at least the new/candidate beam RS(s)/RS resource(s) associated or specific or corresponding to the potential/candidate event occurrence(s) determined or identified or declared by (higher layer(s) of) the UE within the time duration specific/corresponding/associated to the PUCCH resource or transmission or transmission occasion of the first UL channel at time t. For this design example, the time window(s) associated/specific to the event instance(s) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure could correspond to or could be sliding time window(s) as specified/defined herein in the present disclosure.

Throughout the present disclosure, when/if (higher layer(s) of) the UE starts a time window/timer of or for or specific to a new/candidate beam RS/RS resource for determining or identifying or declaring event instance(s) according to or following those specified herein in the present disclosure,
In one example, before the end of the time window or before the timer expires, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may start another time window/timer of or for or specific to a/the same new/candidate beam RS/RS resource for determining or identifying or declaring event instance(s) according to or following those specified herein in the present disclosure no earlier than the end of the time window or the expiration of the timer.
In another example, after (higher layer(s)) of the UE has started the time window/timer, (higher layer(s) of) the UE could start a prohibit timer specific/corresponding/associated to the time window/timer. In this case, when/if the prohibit timer is running, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may not start another time window/timer of or for or specific to a/the same new/candidate beam RS/RS resource for determining or identifying or declaring event instance(s) according to or following those specified herein in the present disclosure before the expiration of the prohibit timer. The UE could determine or identify value(s)/duration(s)/length(s) of the prohibit timer (e.g., in slot(s)/symbol(s)/ms/etc.) based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Throughout the present disclosure, a time duration, a time window, a time offset, a time gap and/or etc. could be equivalent such that they can be used in an exchangeable manner.

Throughout the present disclosure, any time duration, time length, time window, time gap or time offset could be in form/terms of (number of) slot(s)/symbol(s) or milli-second, i.e., ms. Furthermore, throughout the present disclosure, within a time window/duration as specified/defined herein in the present disclosure, (higher layer(s) of) the UE could reset the counting of event instance(s), e.g., to zero, when/if one or more of the following conditions are achieved or satisfied:
The UE receives a TCI state update within the time window/duration
The UE receives a TCI state update within the time window/duration, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window/duration
The UE receives a (unified) TCI state(s) activation/deactivation MAC CE within the time window/duration
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window/duration
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure within the time window/duration, wherein the UE could determine or identify the value of m according to or following those specified herein in the present disclosure
The UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window/duration, wherein the UE could determine or identify the value of m according to or following those specified herein in the present disclosure
The UE receives a beam failure recover response (BFRR) within the time window/duration
The UE or higher layer(s) of the UE starts (or does not start) a prohibit timer as defined/specified herein in the present disclosure within the time window/duration, and/or the prohibit timer does not expire (or expires) within the time window/duration
For Mode-A/Mode-B, the UE receives a DCI in Step-2 in response to the transmission of the PN message/trigger in Step-1 within the time window/duration
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window/duration
The UE receives triggering of aperiodic or semi-persistent CSI measurement and/or reporting (e.g., via a CSI request field in a triggering DCI) within the time window/duration
The UE receives activation of semi-persistent CSI measurement and/or reporting (e.g., via SP CSI measurement and/or reporting activation MAC CE(s)) within the time window/duration, wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

For the (above) described or specified design examples in the present disclosure, the UE could perform or conduct or carry out or do the aforementioned determination or identification or declaration of an/the event, and/or instance(s) of the aforementioned determination or identification or declaration of an/the event could be:
for each periodic PUCCH resource or transmission or transmission occasion of the first UL channel
based on or according to (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling
with a periodicity, wherein
   the periodicity could be the same as the periodicity of the PUCCH resource(s)/transmission(s)/transmission occasion(s) of the first UL channel
   the periodicity could be a fixed value in system specification(s) and/or per RRC (re-)configuration
   the periodicity could be determined by the UE and subject to a corresponding UE's capability/capability signaling
   the periodicity could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling
with a (minimum) time gap/offset between two adjacent or neighboring instances of determination or identification or declaration of an/the event, wherein
   the (minimum) time gap/offset could be the same as the periodicity of the PUCCH resource(s)/transmission(s)/transmission occasion(s) of the first UL channel
   the (minimum) time gap/offset could be a fixed value in system specification(s) and/or per RRC (re-)configuration
   the (minimum) time gap/offset could be determined by the UE and subject to a corresponding UE's capability/capability signaling
   the (minimum) time gap/offset could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling

For the (above) described or specified design examples in the present disclosure, within the time window, when/if the UE
receives a TCI state update
receives a TCI state update, and the (measured) current beam RS/RS resource associated/specific to or determined/identified based on or according to the TCI state update or updated TCI state according to or following those specified herein in the present disclosure is updated/changed in contrast to or different from the previous one
receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure
receives a (unified) TCI state(s) activation/deactivation MAC CE
receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure
receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure, wherein the UE could determine or identify the value of m according to or following those specified herein in the present disclosure
receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the UE could determine or identify the value of m according to or following those specified herein in the present disclosure
receives a beam failure recover response (BFRR)
starts (or does not start) a prohibit timer as defined/specified herein in the present disclosure, and/or the prohibit timer does not expire (or expires)
for Mode-A/Mode-B, receives a DCI in Step-2 in response to the transmission of the PN message/trigger in Step-1
receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
receives triggering of aperiodic or semi-persistent CSI measurement and/or reporting (e.g., via a CSI request field in a triggering DCI)
receives activation of semi-persistent CSI measurement and/or reporting (e.g., via SP CSI measurement and/or reporting activation MAC CE(s))
the UE could reset the number/counting of the event instance(s) determined or identified or declared
within the corresponding time window
before the reception of the TCI state update
before the reception of the (unified) TCI state(s) activation/deactivation MAC CE
for Mode-A/Mode-B, before the reception of the DCI in Step-2 in response to the transmission of the PN message/trigger in Step-1 before the reception of the reconfiguration of new beam RS(s) or RS resource(s)
before the reception of the triggering of aperiodic or semi-persistent CSI measurement and/or reporting (e.g., via a CSI request field in a triggering DCI)
before the reception of the activation of semi-persistent CSI measurement and/or reporting (e.g., via SP CSI measurement and/or reporting activation MAC CE(s))
to zero, wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In one example, for one or more RSs or RS resources each corresponding to one or more of: (1) a (same) new/candidate beam RS/RS resource (e.g., for Event-1 or Event-3), (2) the current beam RS/RS resource (e.g., for Event-2), (3) (a pair of) a (same) new/candidate beam RS/RS resource and a (same) activation beam RS/RS resource (or equivalently, a (same) activated beam/TCI state)—e.g., for Event-3, the MAC entity of/for a UE could or shall for each Serving Cell configured/enabled for UE-initiated/event-driven beam reporting according to those specified herein in the present disclosure:
1> to initiate or trigger a UEI/event-driven beam reporting based on or according to detection or declaration or determination of an event (e.g., Event-1, Event-2 and/or Event-3 in the present disclosure), e.g., to transmit or trigger or initiate a transmission of the PN message/trigger over/on/via/in the PUCCH resource or PUCCH transmission or PUCCH transmission occasion of the first UL channel in Mode A and/or Mode B and/or Mode C at time t:
   2> if an indication for an event instance (e.g., an Event-1 instance or an Event-2 instance or an Event-3 instance) associated/specific to the one or more RSs or RS resources determined or identified according to or following those specified herein in the present disclosure has been received from lower layers:
      3> start or restart an EventInstanceDetectionTimer (higher layer configured for the event-when/if applicable), e.g., associated/specific to the one or more RSs or RS resources;
      3> increment an EventInstanceCounter (higher layer configured for the event-when/if applicable), e.g., associated/specific to the one or more RSs or RS resources by 1;
      3> if EventInstanceCounter>=EventInstanceMaxCount (higher layer configured for the event-when/if applicable), identify or determine or detect or declare a first potential/candidate event occurrence, e.g., associated/specific to the one or more RSs or RS resources, according to or following those specified herein in the present disclosure:
         4> if the identification or determination or detection or declaration of the first potential/candidate event occurrence is within a time duration starting from time t−T_du-T_proc (e.g., in form of a slot or a symbol, i.e., slot or symbol t−T_du-T_proc or the (t−T_du-T_proc)-th slot or symbol) and ending at time t−T_proc—e.g., the time duration here could be associated/specific/corresponding to the PUCCH resource or transmission or transmission occasion of the first UL channel in Mode-A and/or Mode-B and/or Mode-C at time t, wherein T_du, T_proc and/or etc. could be determine or identified according to or following those specified herein in the present disclosure, and/or
         4> if there is no other potential/candidate event occurrence(s), e.g., associated/specific to the same one or more RSs or RS resources, identified or determined within the aforementioned time window starting from time t−T_du-T_proc (e.g., in form of a slot or a symbol, i.e., slot or symbol t−T_du-T_proc or the (t−T_du-T_proc)-th slot or symbol) and ending at time t−T_proc and later in time than the identification or determination or detection of the first potential/candidate event occurrence
         5> trigger or initiate a transmission of the PN message/trigger over/on/via/in the PUCCH resource or PUCCH transmission or PUCCH transmission occasion of the first UL channel at time t according to or based on (identification, determination, detection or declaration of) at least the first potential/candidate event occurrence, wherein the report content(s)/quantity(s) in the UEI beam report(s) could be determined or identified according to or based on (identification, determination, detection or declaration of) at least the first potential/candidate event occurrence (hence, the one or more RSs or RS resources associated/specific to the first potential/candidate event occurrence);
   2> if one or more of the following conditions are satisfied or achieved:
      the EventInstance DetectionTimer, e.g., associated/specific to the one or more RSs or RS resources, expires the UE receives a TCI state update
      the UE receives a (unified) TCI state(s) activation/deactivation MAC CE
      the UE receives a (unified) TCI state(s) activation/deactivation MAC CE that activates or updates the activation beam RS(s)/RS resource(s), and therefore, the corresponding activated beam(s)/TCI state(s), used for determining or identifying the first candidate/potential event occurrence according to or following those specified herein in the present disclosure
      the UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command used for determining or identifying the first candidate/potential event occurrence according to or following those specified herein in the present disclosure, wherein the UE could determine or identify the value of m according to or following those specified herein in the present disclosure
      the UE receives a (unified) TCI state(s) activation/deactivation MAC CE that activates or updates at least one activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure-used for determining or identifying the first candidate/potential event occurrence, wherein the UE could determine or identify the value of m according to or following those specified herein in the present disclosure
      the UE receives a beam failure recover response (BFRR)
      for Mode-A/Mode-B, the UE receives a DCI in Step-2 in response to the transmission of the PN message/trigger in Step-1
      the UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
      the UE receives reconfiguration/update/addition/removal/release (e.g., via/by/in upper layer(s) and/or RRC signaling(s) and/or MAC CE command(s) and/or dynamic DCI based L1 signaling(s)) of the one or more RSs or RS resources
      the UE receives triggering of aperiodic or semi-persistent CSI measurement and/or reporting (e.g., via a CSI request field in a triggering DCI)
      the UE receives activation of semi-persistent CSI measurement and/or reporting (e.g., via SP CSI measurement and/or reporting activation MAC CE(s))
      3> set EventInstanceCounter, e.g., associated/specific to the one or more RSs or RS resources, to 0.

The one or more RSs or RS resources could belong to or could be a subset of or one(s) of all the RS(s) or RS resource(s) configured, provided, determined or identified for event evaluation(s) according to or following those specified/described herein in the present disclosure, wherein one or more of or each of the RS(s) or RS resource(s) configured, provided, determined or identified for event evaluation(s) could correspond to one or more of:
the current beam RS/RS resource
new/candidate beam RS(s)/RS resource(s) in the corresponding resource set
activation beam RS(s)/RS resource(s) in the corresponding activated TCI state(s), e.g., provided/indicated in a (unified) TCI state(s) activation/deactivation MAC CE
Pair(s) of new/candidate beam RS(s)/RS resource(s) in the corresponding resource set and activation beam RS(s)/RS resource(s) in the corresponding activated TCI state(s), e.g., provided/indicated in a (unified) TCI state(s) activation/deactivation MAC CE

According to or following those specified herein in the present disclosure, a UE or higher layer(s) of the UE could trigger or initiate a transmission of the PN message/trigger over/on/via/in the PUCCH resource or PUCCH transmission or PUCCH transmission occasion of the first UL channel in Mode A and/or Mode B and/or Mode C according to or based on (identification, determination, detection or declaration of) one or more potential/candidate event occurrences, wherein each of the one or more potential/candidate event occurrences could be associated/specific to different/separate (sets of) RSs or RS resources. In this case, the corresponding UEI/event-driven beam report(s)—e.g., carried or conveyed or transmitted or sent via PUSCH resource(s) of the second UL channel in Mode A and/or Mode B and/or Mode C associated/specific to the transmission of the PN message/trigger over/on/via/in the PUCCH resource or PUCCH transmission or PUCCH transmission occasion of the first UL channel in Mode A and/or Mode B and/or Mode C-could comprise or include or contain report content(s)/quantity(s) including resource indicator(s) such as SSBRI(s)/CRI(s) and beam metric(s) such as L1-RSRP(s)/L1-SINR(s) determined or identified according to or based on (identification, determination, detection or declaration of) the one or more potential/candidate event occurrences (hence, the RS(s) or RS resource(s) associated/specific to the potential/candidate event occurrence(s)
A UE or higher layer(s) of a UE could start a prohibit timer (duration, length and/or etc. of the prohibit timer and/or how/when the prohibit timer would expire could be higher layer configured) after the last symbol/slot/etc. of transmitting a PN message/trigger on/over/in a PUCCH resource or a PUCCH transmission/transmission occasion of the first UL channel of Mode A and/or Mode B and/or Mode C, and/or
   after the last symbol/slot/etc. of receiving the UL grant DCI in Step-2 of Mode A and/or Mode C, and/or
   after the last symbol/slot/etc. of when the UL grant DCI received in Step-2 of Mode A and/or Mode C has become applicable, and/or
   after the last symbol/slot/etc. of transmitting a beam report on/over/in (DG and/or CG e.g. Type1 CG) PUSCH resource(s) of the second UL channel of Mode A and/or Mode B and/or Mode C.
When a prohibit timer is running, the UE or higher layer(s) of the UE may not transmit any PN message(s)/trigger(s)/notification(s) on/over/in a PUCCH resource or a PUCCH transmission/transmission occasion of the first UL channel (e.g., in Mode A, Mode B and/or Mode C). That is, only when there is no prohibit timer running, the UE or higher layer(s) of the UE could transmit a PN message/trigger on/over/in a PUCCH resource or a PUCCH transmission/transmission occasion of the first UL channel (e.g., in Mode A, Mode B and/or Mode C). In addition, when/if a prohibit timer is running, and/or when/if the duration, length and/or etc. of the prohibit timer is less/smaller (or larger/greater) than or equal to a threshold,
   in one example, the UE or higher layer(s) of the UE could continue performing or conducting the event evaluation(s) including counting of the event instance(s) according to or following those specified herein in the present disclosure; in this case,
      for example, when/if the UE or higher layer(s) of the UE starts the prohibit timer, the UE or higher layer(s) of the UE may not reset the number/counting of the event instance(s), e.g., to zero, and could continue/keep incrementing the number/counting of the (same) event instance(s) counted before the prohibit timer starts according to or following those specified herein in the present disclosure;
      for another example, when/if the UE or higher layer(s) of the UE starts the prohibit timer, the UE or higher layer(s) of the UE could or may reset the number/counting of the event instance(s), e.g., to zero;
      for another example, when/if or after the prohibit timer expires, the UE or higher layer(s) of the UE could or may reset the number/counting of the event instance(s), e.g., to zero;
   in another example, the UE or higher layer(s) of the UE could stop performing or conducting the event evaluation(s) including counting of the event instance(s) according to or following those specified herein in the present disclosure; in this case,
      for example, when/if the UE or higher layer(s) of the UE starts the prohibit timer, the UE or higher layer(s) of the UE could or may reset the number/counting of the event instance(s), e.g., to zero;
      for another example, when/if the UE or higher layer(s) of the UE starts the prohibit timer, the UE or higher layer(s) of the UE may not reset the number/counting of the event instance(s), e.g., to zero, and when/if or after the prohibit timer expires, the UE or higher layer(s) of the UE could continue/keep incrementing the number/counting of the (same) event instance(s) counted before the prohibit timer starts according to or following those specified herein in the present disclosure

The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n times with n=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_puch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure 0 min {periodicity of a first MO, periodicity of a second MO}
max {periodicity of a first MO, periodicity of a second MO}
max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Otherwise, e.g., when/if a prohibit timer is running, and/or when/if the duration, length and/or etc. of the prohibit timer is larger/greater (or less/smaller) than or equal to the threshold specified herein in the present disclosure,
the UE or higher layer(s) of the UE could stop performing or conducting the event evaluation(s) including counting of the event instance(s) according to or following those specified herein in the present disclosure, and/or
when/if the UE or higher layer(s) of the UE starts the prohibit timer, the UE or higher layer(s) of the UE could or may reset the number/counting of the event instance(s), e.g., to zero, and/or
when/if or after the prohibit timer expires, the UE or higher layer(s) of the UE could or may reset the number/counting of the event instance(s), e.g., to zero, and/or
when/if or after the prohibit timer expires, the UE or higher layer(s) of the UE may not continue/keep incrementing the number/counting of the (same) event instance(s) counted before the prohibit timer starts according to or following those specified herein in the present disclosure.

Regarding the event instance(s) specified/discussed herein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In addition, UE could determine or identify the value of n according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, when/if a UE or higher layer(s) of a UE has determined or detected or declared an event and there is no prohibit timer running, the UE could transmit a PN message/trigger on/over/in/by a first PUCCH resource or a first PUCCH transmission/transmission occasion (of the first UL channel) at time t, wherein the UE could determine or identify association(s)/linkage(s)/correspondence(s)—e.g., in terms of their timing relations-between the determination or detection or declaration of the event and the first PUCCH resource or first PUCCH transmission or first PUCCH transmission occasion at time t according to or following those specified herein in the present disclosure. When/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′ to transmit a PN message/trigger based on the determination, detection or declaration of the event according to or following those specified herein in the present disclosure, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′.

Furthermore, delta_t=t′−t could be smaller/less (or larger/greater) than or equal to a threshold. The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n′ times with n′=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min {periodicity of a first MO, periodicity of a second MO}
max {periodicity of a first MO, periodicity of a second MO}
max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). In addition, the UE could determine or identify the value of n′ according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Alternatively, when/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′. When/if delta_t=t′−t is greater/larger (or less/smaller) than or equal to the threshold specified herein in the present disclosure, the UE may not transmit a PN message/trigger on/over/in/by the second PUCCH resource or second PUCCH transmission/transmission occasion of the first UL channel at time t′ based on the determination, detection or declaration of the event according to or following those specified herein in the present disclosure, and/or
the UE may not transmit any PN message(s)/trigger(s) on/over/in/by any PUCCH resource(s) or any PUCCH transmission(s)/transmission occasion(s) of the first UL channel based on the determination, detection or declaration of the event according to or following those specified herein in the present disclosure.

According to or following those specified herein in the present disclosure, a UE could perform or conduct event(s) evaluation(s) and/or event instance(s) evaluation(s) in MAC/L2/L3/upper layer(s) and/or PHY/L1/lower layer(s). The UE could determine or identify MAC/L2/L3/upper layer(s) and/or PHY/L1/lower layer(s) to evaluate the event(s) or the event instance(s) according to or following those specified herein in the present disclosure according to or based on: fixed rule(s) in system specification(s) and/or per RRC (re-) configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In one example, when/if Mode A (or Mode C) is enabled, the UE could perform or conduct event(s) evaluation(s) and/or event instance(s) evaluation(s) in MAC/L2/L3/upper layer(s); otherwise, i.e., when/if Mode B (or Mode C) is enabled, the UE could perform or conduct event(s) evaluation(s) and/or event instance(s) evaluation(s) in PHY/L1/lower layer(s).
In another example, when/if a (dedicated) SR (e.g., the corresponding SR configuration is associated with a SR ID or SR configuration ID) is used as the first UL channel, the UE could perform or conduct event(s) evaluation(s) and/or event instance(s) evaluation(s) in MAC/L2/L3/upper layer(s); otherwise, e.g., when/if a UCI (e.g., having a PUCCH resource configuration not associated with a SR ID or SR configuration ID) is used as the first UL channel, the UE could perform or conduct event(s) evaluation(s) and/or event instance(s) evaluation(s) in PHY/L1/lower layer(s).

Supporting evaluation(s) of event(s)/event instance(s) in MAC/L2/L3/upper layer(s) (and/or in PHY/L1/lower layer(s)) could be a basic UE feature such that when/if a UE supports the UE-initiated/event-driven beam reporting/management (or for a UE supporting the UE-initiated/event-driven beam reporting/management), the UE could or would need to support at least evaluation(s) of event(s)/event instance(s) in MAC/L2/L3/upper layer(s) (and/or in PHY/L1/lower layer(s)). Supporting evaluation(s) of event(s)/event instance(s) in PHY/L1/lower layer(s) (and/or in MAC/L2/L3/upper layer(s)) could be optional for a UE supporting the UE-initiated/event-driven beam reporting/management; in this case, the UE could indicate to the network in their capability signaling(s) one or more of:
Support of event(s)/event instance(s) evaluation(s) in MAC/L2/L3/upper layer(s)
Support of event(s)/event instance(s) evaluation(s) in PHY/L1/lower layer(s)
That is, a UE's capability or capability signaling could comprise one or more components each indicating support of:
{event(s)/event instance(s) evaluation(s) in MAC/L2/L3/upper layer(s)}
{event(s)/event instance(s) evaluation(s) in PHY/L1/lower layer(s)}
{event(s)/event instance(s) evaluation(s) in MAC/L2/L3/upper layer(s), event(s)/event instance(s) evaluation(s) in PHY/L1/lower layer(s)}

According to or following those specified herein in the present disclosure, for Mode A, Mode B and/or Mode C, the UE could send or transmit a first message (or equivalently a PN message/trigger or a UEITI) by/in/on one or more PUCCHs/PUCCH resources of the first UL channel as in Step-1 to activate and/or deactivate one or more of the (L≥1) measurement RS resources, wherein the UE could determine or identify the measurement RS resources according to or based on or as one or more of:
the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.

In this case, the first message could be in form of or could correspond to one or more of:
a one-bit indicator:
   for example, for L=2 measurement RS resources, when/if the one-bit indicator is set to ‘1’ (or ‘0’), the first measurement RS resource or the measurement RS resource with the lowest resource ID/index could be activated, and/or the second measurement RS resource or the measurement RS resource with the highest resource ID/index could be deactivated; and/or when/if the one-bit indicator is set to ‘0’ (or ‘1’), the first measurement RS resource or the measurement RS resource with the lowest resource ID/index could be deactivated, and/or the second measurement RS resource or the measurement RS resource with the highest resource ID/index could be activated;
   for another example, the UE could first determine or identify the L measurement RS resources into two resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, when/if the one-bit indicator is set to ‘1’ (or ‘0’), the measurement RS resource(s) in the first resource set/group e.g. with the lowest resource set/group ID/index could be activated, and/or the measurement RS resource(s) in the second resource set/group e.g. with the highest resource set/group ID/index could be deactivated; and/or when/if the one-bit indicator is set to ‘0’ (or ‘1’), the measurement RS resource(s) in the first resource set/group e.g. with the lowest resource set/group ID/index could be deactivated, and/or the measurement RS resource(s) in the second resource set/group e.g. with the highest resource set/group ID/index could be activated;
a k-bit (k≥1) indicator:
   for example, for k=[log₂L], when/if the first codepoint of the k-bit indicator is indicated, the first measurement RS resource or the measurement RS resource with the lowest resource ID/index could be activated, and/or the rest of the (L−1) measurement RS resource(s) could be deactivated, when/if the second codepoint of the k-bit indicator is indicated, the second measurement RS resource or the measurement RS resource with the second lowest resource ID/index could be activated, and/or the rest of the (L−1) measurement RS resource(s) could be deactivated, and so on, and/or when/if the last codepoint of the k-bit indicator is indicated, the L-th (or last) measurement RS resource or the measurement RS resource with the highest resource ID/index could be activated, and/or the rest of the (L−1) measurement RS resource(s) could be deactivated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=[log₂K], when/if the first codepoint of the k-bit indicator is indicated, the measurement RS resource(s) in the first resource set/group e.g. with the lowest resource set/group ID/index could be activated, and/or the measurement RS resource(s) in the rest of the (K−1) measurement RS resource set(s)/group(s) could be deactivated, when/if the second codepoint of the k-bit indicator is indicated, the measurement RS resource(s) in the second resource set/group e.g. with the second lowest resource set/group ID/index could be activated, and/or the measurement RS resource(s) in the rest of the (K−1) measurement RS resource set(s)/group(s) could be deactivated, and so on, when/if the last codepoint of the k-bit indicator is indicated, the measurement RS resource(s) in the K-th (or last) resource set/group e.g. with the lowest resource set/group ID/index could be activated, and/or the measurement RS resource(s) in the rest of the (K−1) measurement RS resource set(s)/group(s) could be deactivated;
a bitmap:
   for example, the bitmap could be of length L with each entry/bit position corresponding, associated or specific to one of the L measurement RS resource(s); when/if an entry/bit position of the bitmap is set to ‘1’ (or ‘0’), the measurement RS or RS resource associated, corresponding or specific to the entry/bit position could be activated, and/or when/if an entry/bit position of the bitmap is set to ‘0’ (or ‘1’), the measurement RS or RS resource associated, corresponding or specific to the entry/bit position could be deactivated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, the bitmap could be of length K with each entry/bit position corresponding, associated or specific to one of the K measurement RS resource set(s)/group(s); when/if an entry/bit position of the bitmap is set to ‘1’ (or ‘0’), the measurement RS(s) or RS resource(s) in the resource set/group associated, corresponding or specific to the entry/bit position could be activated, and/or when/if an entry/bit position of the bitmap is set to ‘0’ (or ‘1’), the measurement RS(s) or RS resource(s) in the resource set/group associated, corresponding or specific to the entry/bit position could be deactivated;
a PUCCH/PUCCH resource with k (sequence) cyclic shift(s)
   for example, for k=L, when/if the first cyclic shift is used for transmitting the first message, the first measurement RS resource or the measurement RS resource with the lowest resource ID/index could be activated, and/or the rest of the (L−1) measurement RS resource(s) could be deactivated, when/if the second cyclic shift is used for transmitting the first message, the second measurement RS resource or the measurement RS resource with the second lowest resource ID/index could be activated, and/or the rest of the (L−1) measurement RS resource(s) could be deactivated, and so on, and/or when/if the last (or L-th) cyclic shift is used for transmitting the first message, the L-th (or last) measurement RS resource or the measurement RS resource with the highest resource ID/index could be activated, and/or the rest of the (L−1) measurement RS resource(s) could be deactivated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=K, when/if the first cyclic shift is used for transmitting the first message, the measurement RS resource(s) in the first resource set/group e.g. with the lowest resource set/group ID/index could be activated, and/or the measurement RS resource(s) in the rest of the (K−1) measurement RS resource set(s)/group(s) could be deactivated, when/if the second cyclic shift is used for transmitting the first message, the measurement RS resource(s) in the second resource set/group e.g. with the second lowest resource set/group ID/index could be activated, and/or the measurement RS resource(s) in the rest of the (K−1) measurement RS resource set(s)/group(s) could be deactivated, and so on, and/or when/if the last (or K-th) cyclic shift is used for transmitting the first message, the measurement RS resource(s) in the last (or K-th) resource group/set e.g. with the highest resource set ID/index could be activated, and/or the measurement RS resource(s) in the rest of the (K−1) measurement RS resource set(s)/group(s) could be deactivated.

According to or following those specified herein in the present disclosure, for Mode A, Mode B and/or Mode C, the UE could send or transmit one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B to carry or convey one or more indicators to activate and/or deactivate one or more of the (L≥1) measurement RS resources, wherein the UE could determine or identify the measurement RS resources according to or based on or as one or more of:
the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.

In this case, the aforementioned one or more indicators conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to or could comprise one or more of:
a one-bit indicator:
   for example, for L=2 measurement RS resources, when/if the one-bit indicator is set to ‘1’ (or ‘0’), the first measurement RS resource or the measurement RS resource with the lowest resource ID/index could be activated, and/or the second measurement RS resource or the measurement RS resource with the highest resource ID/index could be deactivated; and/or when/if the one-bit indicator is set to ‘0’ (or ‘1’), the first measurement RS resource or the measurement RS resource with the lowest resource ID/index could be deactivated, and/or the second measurement RS resource or the measurement RS resource with the highest resource ID/index could be activated;
   for another example, the UE could first determine or identify the L measurement RS resources into two resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, when/if the one-bit indicator is set to ‘1’ (or ‘0’), the measurement RS resource(s) in the first resource set/group e.g. with the lowest resource set/group ID/index could be activated, and/or the measurement RS resource(s) in the second resource set/group e.g. with the highest resource set/group ID/index could be deactivated; and/or when/if the one-bit indicator is set to ‘0’ (or ‘1’), the measurement RS resource(s) in the first resource set/group e.g. with the lowest resource set/group ID/index could be deactivated, and/or the measurement RS resource(s) in the second resource set/group e.g. with the highest resource set/group ID/index could be activated;
one or more one-bit indicators:
   for example, each of the one or more one-bit indicators could be associated, corresponding or specific to one of the L measurement RS resource(s); when/if a/the k-th (k belongs to {1, . . . , L}) one-bit indicator is set to ‘1’ (or ‘0’), the k-th measurement RS resource or the measurement RS resource with the k-th lowest resource ID/index could be activated, and/or when/if the k-th one-bit indicator is set to ‘0’ (or ‘1’), the k-th measurement RS resource or the measurement RS resource with the k-th lowest resource ID/index could be deactivated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, each of the one or more one-bit indicators could be associated, corresponding or specific to one of the K measurement RS resource set(s)/group(s); when/if a/the k-th (k belongs to {1, . . . , K}) one-bit indicator is set to ‘1’ (or ‘0’), the measurement RS resource(s) in the k-th resource set/group e.g. with the k-th lowest resource set/group ID/index could be activated, and/or when/if a/the k-th (k belongs to {1, . . . , K}) one-bit indicator is set to ‘0’ (or ‘1’), the measurement RS resource(s) in the k-th resource set/group e.g. with the k-th lowest resource set/group ID/index could be deactivated;
ak-bit (k≥1) indicator:
   for example, for k=[log₂L], when/if the first codepoint of the k-bit indicator is indicated, the first measurement RS resource or the measurement RS resource with the lowest resource ID/index could be activated, and/or the rest of the (L−1) measurement RS resource(s) could be deactivated, when/if the second codepoint of the k-bit indicator is indicated, the second measurement RS resource or the measurement RS resource with the second lowest resource ID/index could be activated, and/or the rest of the (L−1) measurement RS resource(s) could be deactivated, and so on, and/or when/if the last codepoint of the k-bit indicator is indicated, the L-th (or last) measurement RS resource or the measurement RS resource with the highest resource ID/index could be activated, and/or the rest of the (L−1) measurement RS resource(s) could be deactivated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=[log₂K], when/if the first codepoint of the k-bit indicator is indicated, the measurement RS resource(s) in the first resource set/group e.g. with the lowest resource set/group ID/index could be activated, and/or the measurement RS resource(s) in the rest of the (K−1) measurement RS resource set(s)/group(s) could be deactivated, when/if the second codepoint of the k-bit indicator is indicated, the measurement RS resource(s) in the second resource set/group e.g. with the second lowest resource set/group ID/index could be activated, and/or the measurement RS resource(s) in the rest of the (K−1) measurement RS resource set(s)/group(s) could be deactivated, and so on, when/if the last codepoint of the k-bit indicator is indicated, the measurement RS resource(s) in the K-th (or last) resource set/group e.g. with the lowest resource set/group ID/index could be activated, and/or the measurement RS resource(s) in the rest of the (K−1) measurement RS resource set(s)/group(s) could be deactivated;
one or more k-bit (k≥1) indicators:
   for example, for k=[log₂L], when/if a k-bit indicator is set to a codepoint of the k-bit indicator corresponding to an index value k′ (k′ belongs to {1, . . . , L}), the k′-th measurement RS resource or the measurement RS resource with the k′-th lowest resource ID/index could be activated, and/or when/if a k-bit indicator is set to a codepoint of the k-bit indicator corresponding to an index value k′, the k′-th measurement RS resource or the measurement RS resource with the k′-th lowest resource ID/index could be deactivated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=[log₂K], when/if a k-bit indicator is set to a codepoint of the k-bit indicator corresponding to an index value k′ (k′ belongs to {1, . . . , K}, the measurement RS resource(s) in the k′-th resource set/group e.g. with the k′-th lowest resource set/group ID/index could be activated, and/or when/if a k-bit indicator is set to a codepoint of the k-bit indicator corresponding to an index value k′ (k′ belongs to {1, . . . , K}, the measurement RS resource(s) in the k′-th resource set/group e.g. with the k′-th lowest resource set/group ID/index could be deactivated;
a bitmap:
   for example, the bitmap could be of length L with each entry/bit position corresponding, associated or specific to one of the L measurement RS resource(s); when/if an entry/bit position of the bitmap is set to ‘1’ (or ‘0’), the measurement RS or RS resource associated, corresponding or specific to the entry/bit position could be activated, and/or when/if an entry/bit position of the bitmap is set to ‘0’ (or ‘1’), the measurement RS or RS resource associated, corresponding or specific to the entry/bit position could be deactivated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, the bitmap could be of length K with each entry/bit position corresponding, associated or specific to one of the K measurement RS resource set(s)/group(s); when/if an entry/bit position of the bitmap is set to ‘1’ (or ‘0’), the measurement RS(s) or RS resource(s) in the resource set/group associated, corresponding or specific to the entry/bit position could be activated, and/or when/if an entry/bit position of the bitmap is set to ‘0’ (or ‘1’), the measurement RS(s) or RS resource(s) in the resource set/group associated, corresponding or specific to the entry/bit position could be deactivated;
one or more RS resource IDs/indexes:
   for example, the measurement RS(s) or RS resource(s)—out of all the L measurement RS resource(s)
      corresponding to the one or more RS resource IDs/indexes or having the same RS resource ID(s)/index(es) as the one or more RS resource IDs/indexes could be activated;
   for another example, the measurement RS(s) or RS resource(s)—out of all the L measurement RS resource(s)—corresponding to the one or more RS resource IDs/indexes or having the same RS resource ID(s)/index(es) as the one or more RS resource IDs/indexes could be deactivated;
one or more RS resource set/group IDs/indexes: the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s).
   for example, the measurement RS(s) or RS resource(s) in the RS resource set(s)/group(s)—out of all the K measurement RS resource set(s)/group(s)—corresponding to the one or more RS resource set/group IDs/indexes or having the same RS resource set/group ID(s)/index(es) as the one or more RS resource set/group IDs/indexes could be activated;
   for another example, the measurement RS(s) or RS resource(s) in the RS resource set(s)/group(s)—out of all the K measurement RS resource set(s)/group(s)—corresponding to the one or more RS resource set/group IDs/indexes or having the same RS resource set/group ID(s)/index(es) as the one or more RS resource set/group IDs/indexes could be deactivated.

According to or following those specified herein in the present disclosure, for Mode A, Mode B and/or Mode C, the UE could send or transmit a first message (or equivalently a PN message/trigger or a UEITI) by/in/on one or more PUCCHs/PUCCH resources of the first UL channel as in Step-1 to indicate to the network whether one or more of the (L≥1) measurement RS resources indicated by one or more indicators carried or conveyed by/in (part of) one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be activated or deactivated, wherein the UE could determine or identify the measurement RS resources according to or based on or as one or more of:
the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.

In this case, the first message could be in form of or could correspond to one or more of:
a one-bit indicator: in this case, when/if the one-bit indicator is set to ‘1’ (or ‘0’), the one or more of the measurement RS resources indicated by the one or more indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be activated, and/or when/if the one-bit indicator is set to ‘0’ (or ‘1’), the one or more of the measurement RS resources indicated by the one or more indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be deactivated;
a PUCCH/PUCCH resource with two (sequence) cyclic shift(s): in this case, when/if the first cyclic shift is used for transmitting the first message, the one or more of the measurement RS resources indicated by the one or more indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be activated, and/or when/if the second cyclic shift is used for transmitting the first message, the one or more of the measurement RS resources indicated by the one or more indicators carried or conveyed by/in (part of) the one or more second messages (or equivalently the UEI report content(s)/quantity(s)) transmitted or sent by/in/on one or more PUSCHs/PUSCH resources of the second UL channel as in Step-3 of Mode-A and/or Mode-C and/or Step-2 of Mode B could be deactivated.
The aforementioned one or more indicators conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to or could comprise one or more of:
a one-bit indicator:
   for example, for L=2 measurement RS resources, when/if the one-bit indicator is set to ‘1’ (or ‘0’), the first measurement RS resource or the measurement RS resource with the lowest resource ID/index could be indicated, and/or the second measurement RS resource or the measurement RS resource with the highest resource ID/index may not be indicated; and/or when/if the one-bit indicator is set to ‘0’ (or ‘1’), the first measurement RS resource or the measurement RS resource with the lowest resource ID/index may not be indicated, and/or the second measurement RS resource or the measurement RS resource with the highest resource ID/index could be indicated;
   for another example, the UE could first determine or identify the L measurement RS resources into two resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, when/if the one-bit indicator is set to ‘1’ (or ‘0’), the measurement RS resource(s) in the first resource set/group e.g. with the lowest resource set/group ID/index could be indicated, and/or the measurement RS resource(s) in the second resource set/group e.g. with the highest resource set/group ID/index may not be indicated; and/or when/if the one-bit indicator is set to ‘0’ (or ‘1’), the measurement RS resource(s) in the first resource set/group e.g. with the lowest resource set/group ID/index may not be indicated, and/or the measurement RS resource(s) in the second resource set/group e.g. with the highest resource set/group ID/index could be indicated;
one or more one-bit indicators:
   for example, each of the one or more one-bit indicators could be associated, corresponding or specific to one of the L measurement RS resource(s); when/if a/the k-th (k belongs to {1, . . . , L}) one-bit indicator is set to ‘1’ (or ‘0’), the k-th measurement RS resource or the measurement RS resource with the k-th lowest resource ID/index could be indicated or may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, each of the one or more one-bit indicators could be associated, corresponding or specific to one of the K measurement RS resource set(s)/group(s); when/if a/the k-th (k belongs to {1, . . . , K}) one-bit indicator is set to ‘1’ (or ‘0’), the measurement RS resource(s) in the k-th resource set/group e.g. with the k-th lowest resource set/group ID/index could be indicated or may not be indicated;
a k-bit (k≥1) indicator:
   for example, for k=[log₂L], when/if the first codepoint of the k-bit indicator is indicated, the first measurement RS resource or the measurement RS resource with the lowest resource ID/index could be indicated, and/or the rest of the (L−1) measurement RS resource(s) may not be indicated, when/if the second codepoint of the k-bit indicator is indicated, the second measurement RS resource or the measurement RS resource with the second lowest resource ID/index could be indicated, and/or the rest of the (L−1) measurement RS resource(s) may not be indicated, and so on, and/or when/if the last codepoint of the k-bit indicator is indicated, the L-th (or last) measurement RS resource or the measurement RS resource with the highest resource ID/index could be indicated, and/or the rest of the (L−1) measurement RS resource(s) may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=[log₂K], when/if the first codepoint of the k-bit indicator is indicated, the measurement RS resource(s) in the first resource set/group e.g. with the lowest resource set/group ID/index could be indicated, and/or the measurement RS resource(s) in the rest of the (K−1) measurement RS resource set(s)/group(s) may not be indicated, when/if the second codepoint of the k-bit indicator is indicated, the measurement RS resource(s) in the second resource set/group e.g. with the second lowest resource set/group ID/index could be indicated, and/or the measurement RS resource(s) in the rest of the (K−1) measurement RS resource set(s)/group(s) may not be indicated, and so on, when/if the last codepoint of the k-bit indicator is indicated, the measurement RS resource(s) in the K-th (or last) resource set/group e.g. with the lowest resource set/group ID/index could be indicated, and/or the measurement RS resource(s) in the rest of the (K−1) measurement RS resource set(s)/group(s) may not be indicated;
one or more k-bit (k≥1) indicators:
   for example, for k=[log₂L], when/if a k-bit indicator is set to a codepoint of the k-bit indicator corresponding to an index value k′ (k′ belongs to {1, . . . , L}), the k′-th measurement RS resource or the measurement RS resource with the k′-th lowest resource ID/index could be indicated or may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=[log₂K], when/if a k-bit indicator is set to a codepoint of the k-bit indicator corresponding to an index value k′ (k′ belongs to {1, . . . , K}, the measurement RS resource(s) in the k′-th resource set/group e.g. with the k′-th lowest resource set/group ID/index could be indicated or may not be indicated;
a bitmap:
   for example, the bitmap could be of length L with each entry/bit position corresponding, associated or specific to one of the L measurement RS resource(s); when/if an entry/bit position of the bitmap is set to ‘1’ (or ‘0’), the measurement RS or RS resource associated, corresponding or specific to the entry/bit position could be indicated or may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, the bitmap could be of length K with each entry/bit position corresponding, associated or specific to one of the K measurement RS resource set(s)/group(s); when/if an entry/bit position of the bitmap is set to ‘1’ (or ‘0’), the measurement RS(s) or RS resource(s) in the resource set/group associated, corresponding or specific to the entry/bit position could be indicated or may not be indicated;
one or more RS resource IDs/indexes: for example, the measurement RS(s) or RS resource(s)—out of all the L measurement RS resource(s)—corresponding to the one or more RS resource IDs/indexes or having the same RS resource ID(s)/index(es) as the one or more RS resource IDs/indexes could be indicated or may not be indicated;
one or more RS resource set/group IDs/indexes: the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For example, the measurement RS(s) or RS resource(s) in the RS resource set(s)/group(s)—out of all the K measurement RS resource set(s)/group(s)—corresponding to the one or more RS resource set/group IDs/indexes or having the same RS resource set/group ID(s)/index(es) as the one or more RS resource set/group IDs/indexes could be indicated or may not be indicated.

According to or following those specified herein in the present disclosure, for Mode A, Mode B and/or Mode C, the UE could send or transmit one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B to carry or convey one or more first indicators (e.g., in part 1 of a two-part UCI/CSI) to indicate to the network whether one or more of the (L≥1) measurement RS resources indicated by one or more second indicators (e.g., in part 2 of a two-part UCI/CSI) carried or conveyed by/in (part of) the (same) one or more second messages (or equivalently the (same) UEI report content(s)/quantity(s)) sent or transmitted by/in/on the one or more PUSCHs/PUSCH resources of the second UL channel as in Step-3 of Mode-A and/or Mode-C and/or Step-2 of Mode B could be activated or deactivated, wherein the UE could determine or identify the measurement RS resources according to or based on or as one or more of:
the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.

In this case, the aforementioned one or more first indicators (e.g., in part 1 of a two-part UCI/CSI) conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to one or more of:
a one-bit indicator: in this case, when/if the one-bit indicator is set to ‘1’ (or ‘0’), the one or more of the measurement RS resources indicated by the one or more second indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be activated, and/or when/if the one-bit indicator is set to ‘0’ (or ‘1’), the one or more of the measurement RS resources indicated by the one or more second indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be deactivated;
a PUCCH/PUCCH resource with two (sequence) cyclic shift(s): in this case, when/if the first cyclic shift is used for transmitting the first message, the one or more of the measurement RS resources indicated by the one or more second indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be activated, and/or when/if the second cyclic shift is used for transmitting the first message, the one or more of the measurement RS resources indicated by the one or more second indicators carried or conveyed by/in (part of) the one or more second messages (or equivalently the UEI report content(s)/quantity(s)) transmitted or sent by/in/on one or more PUSCHs/PUSCH resources of the second UL channel as in Step-3 of Mode-A and/or Mode-C and/or Step-2 of Mode B could be deactivated.

The aforementioned one or more second indicators (e.g., in part 2 of the two-part UCI/CSI) conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to or could comprise one or more of:
a one-bit indicator:
   for example, for L=2 measurement RS resources, when/if the one-bit indicator is set to ‘1’ (or ‘0’), the first measurement RS resource or the measurement RS resource with the lowest resource ID/index could be indicated, and/or the second measurement RS resource or the measurement RS resource with the highest resource ID/index may not be indicated; and/or when/if the one-bit indicator is set to ‘0’ (or ‘1’), the first measurement RS resource or the measurement RS resource with the lowest resource ID/index may not be indicated, and/or the second measurement RS resource or the measurement RS resource with the highest resource ID/index could be indicated;
   for another example, the UE could first determine or identify the L measurement RS resources into two resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, when/if the one-bit indicator is set to ‘1’ (or ‘0’), the measurement RS resource(s) in the first resource set/group e.g. with the lowest resource set/group ID/index could be indicated, and/or the measurement RS resource(s) in the second resource set/group e.g. with the highest resource set/group ID/index may not be indicated; and/or when/if the one-bit indicator is set to ‘0’ (or ‘1’), the measurement RS resource(s) in the first resource set/group e.g. with the lowest resource set/group ID/index may not be indicated, and/or the measurement RS resource(s) in the second resource set/group e.g. with the highest resource set/group ID/index could be indicated;
one or more one-bit indicators:
   for example, each of the one or more one-bit indicators could be associated, corresponding or specific to one of the L measurement RS resource(s); when/if a/the k-th (k belongs to {1, . . . , L}) one-bit indicator is set to ‘1’ (or ‘0’), the k-th measurement RS resource or the measurement RS resource with the k-th lowest resource ID/index could be indicated or may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, each of the one or more one-bit indicators could be associated, corresponding or specific to one of the K measurement RS resource set(s)/group(s); when/if a/the k-th (k belongs to {1, . . . , K}) one-bit indicator is set to ‘1’ (or ‘0’), the measurement RS resource(s) in the k-th resource set/group e.g. with the k-th lowest resource set/group ID/index could be indicated or may not be indicated;
ak-bit (k≥1) indicator:
   for example, for k=[log₂L], when/if the first codepoint of the k-bit indicator is indicated, the first measurement RS resource or the measurement RS resource with the lowest resource ID/index could be indicated, and/or the rest of the (L−1) measurement RS resource(s) may not be indicated, when/if the second codepoint of the k-bit indicator is indicated, the second measurement RS resource or the measurement RS resource with the second lowest resource ID/index could be indicated, and/or the rest of the (L−1) measurement RS resource(s) may not be indicated, and so on, and/or when/if the last codepoint of the k-bit indicator is indicated, the L-th (or last) measurement RS resource or the measurement RS resource with the highest resource ID/index could be indicated, and/or the rest of the (L−1) measurement RS resource(s) may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=[log₂K], when/if the first codepoint of the k-bit indicator is indicated, the measurement RS resource(s) in the first resource set/group e.g. with the lowest resource set/group ID/index could be indicated, and/or the measurement RS resource(s) in the rest of the (K−1) measurement RS resource set(s)/group(s) may not be indicated, when/if the second codepoint of the k-bit indicator is indicated, the measurement RS resource(s) in the second resource set/group e.g. with the second lowest resource set/group ID/index could be indicated, and/or the measurement RS resource(s) in the rest of the (K−1) measurement RS resource set(s)/group(s) may not be indicated, and so on, when/if the last codepoint of the k-bit indicator is indicated, the measurement RS resource(s) in the K-th (or last) resource set/group e.g. with the lowest resource set/group ID/index could be indicated, and/or the measurement RS resource(s) in the rest of the (K−1) measurement RS resource set(s)/group(s) may not be indicated;
one or more k-bit (k≥1) indicators:
   for example, for k=[log₂L], when/if a k-bit indicator is set to a codepoint of the k-bit indicator corresponding to an index value k′ (k′ belongs to {1, . . . , L}), the k′-th measurement RS resource or the measurement RS resource with the k′-th lowest resource ID/index could be indicated or may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, k=[log₂K], when/if a k-bit indicator is set to a codepoint of the k-bit indicator corresponding to an index value k′ (k′ belongs to {1, . . . , K}, the measurement RS resource(s) in the k′-th resource set/group e.g. with the k′-th lowest resource set/group ID/index could be indicated or may not be indicated;
a bitmap:
   for example, the bitmap could be of length L with each entry/bit position corresponding, associated or specific to one of the L measurement RS resource(s); when/if an entry/bit position of the bitmap is set to ‘1’ (or ‘0’), the measurement RS or RS resource associated, corresponding or specific to the entry/bit position could be indicated or may not be indicated;
   for another example, the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For this design example, the bitmap could be of length K with each entry/bit position corresponding, associated or specific to one of the K measurement RS resource set(s)/group(s); when/if an entry/bit position of the bitmap is set to ‘1’ (or ‘0’), the measurement RS(s) or RS resource(s) in the resource set/group associated, corresponding or specific to the entry/bit position could be indicated or may not be indicated;
one or more RS resource IDs/indexes: for example, the measurement RS(s) or RS resource(s)—out of all the L measurement RS resource(s)—corresponding to the one or more RS resource IDs/indexes or having the same RS resource ID(s)/index(es) as the one or more RS resource IDs/indexes could be indicated or may not be indicated;
one or more RS resource set/group IDs/indexes: the UE could first determine or identify the L measurement RS resources into K≥1 resource sets/groups according to or based on: (i) fixed rule(s)/value(s) in system specification(s) and/or per RRC (re-)configuration, (ii) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (iii) a corresponding UE's capability or capability signaling, and/or (iv) UE's autonomous determination or selection, which could be further sent or indicated or transmitted to the network via various UL channels/signals including beam/CSI report(s) and/or UE's capability signaling(s). For example, the measurement RS(s) or RS resource(s) in the RS resource set(s)/group(s)—out of all the K measurement RS resource set(s)/group(s)—corresponding to the one or more RS resource set/group IDs/indexes or having the same RS resource set/group ID(s)/index(es) as the one or more RS resource set/group IDs/indexes could be indicated or may not be indicated.

The UE could expect to receive a response from the network to the one or more (first) indicators sent or transmitted by/in (part of) the first message (or equivalently a PN message/trigger or a UEITI) sent or transmitted by/in/on one or more PUCCHs/PUCCH resources of the first UL channel as in Step-1, if any,
no earlier than X1 symbol(s)/slot(s) and/or no later than X2 symbol(s)/slot(s) after a/the last (or first) symbol/slot/etc. of transmitting or transmission(s) of the first message (or equivalently a PN message/trigger or a UEITI) by/in/on one or more PUCCHs/PUCCH resources of the first UL channel as in Step-1, and/or
starting from a/the first symbol/slot/etc. that is at least X3 symbol(s)/slot(s) after a/the last (or first) symbol/slot/etc. of transmitting or transmission(s) of the first message (or equivalently a PN message/trigger or a UEITI) by/in/on one or more PUCCHs/PUCCH resources of the first UL channel as in Step-1.

The UE could determine or identify value(s) of X1, X2 and/or X3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the NWR could be provided or configured or indicated by the network in form of RRC signaling(s)/parameter(s) and/or MAC CE command(s) and/or dynamic DCI based L1 signaling(s) based on or according to corresponding UE's capability(s) or capability signaling(s). When/if the NWR is indicated in/via/by a DCI based L1 signaling, the corresponding DCI can be a downlink DCI of format 1_0, 1_3, 1_1 and/or 1_2 with or without DL assignment, an uplink DCI of format 0_0, 0_3, 0_1 and/or 0_2 with or without UL grant, or a dedicated DCI format for TCI state(s) indication, switching and/or update and/or etc. For instance, the NWR could be indicated in/via/by the DCI as in Step-2 of Mode A and/or Mode C as specified/defined herein in the present disclosure, and the NWR could be in form of:
a one-bit (ACK/NACK) indicator which can be set to ‘l’ or ‘0’
one or more indicators to activate and/or trigger and/or deactivate transmission(s) of one or more RSs, which could correspond to the one or more of the measurement RS resources requested or indicated or initiated or triggered by the one or more (first) indicators sent or transmitted by/in (part of) the first message (or equivalently a PN message/trigger or a UEITI) by/in/on one or more PUCCHs/PUCCH resources of the first UL channel as in Step-1 for activation and/or deactivation according to or following those specified/defined herein in the present disclosure.

The NWR could be indicated by e.g. a/the CSI request field in the corresponding DCI format(s) e.g. 0_1/0_2; alternatively, the NWR could correspond to a dedicated/new DCI field in the corresponding DCI format(s), or optionally the NWR could be realized or implemented in the corresponding DCI format(s) by repurposing one or more codepoints of one or more existing DCI fields. The UE could receive, monitor, assess and/or measure the one or more RSs activated and/or triggered by the network,
no earlier than Y1 symbol(s)/slot(s) and/or no later than Y2 symbol(s)/slot(s) after a/the last (or first) symbol/slot/etc. of receiving or reception of the NWR, and/or
starting from a/the first symbol/slot/etc. that is at least Y3 symbol(s)/slot(s) after a/the last (or first) symbol/slot/etc. of receiving or reception of the NWR.

The UE could determine or identify value(s) of Y1, Y2 and/or Y3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The UE could expect to receive a response from the network to the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B, if any,
no earlier than X1′ symbol(s)/slot(s) and/or no later than X2′ symbol(s)/slot(s) after a/the last (or first) symbol/slot/etc. of transmitting or transmission(s) of the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B, and/or
starting from a/the first symbol/slot/etc. that is at least X3′ symbol(s)/slot(s) after a/the last (or first) symbol/slot/etc. of transmitting or transmission(s) of the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B.

The UE could determine or identify value(s) of X1′, X2′ and/or X3′ according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the NWR could be provided or configured or indicated by the network in form of RRC signaling(s)/parameter(s) and/or MAC CE command(s) and/or dynamic DCI based L1 signaling(s) based on or according to corresponding UE's capability(s) or capability signaling(s). When/if the NWR is indicated in/via/by a DCI based L1 signaling, the corresponding DCI can be a downlink DCI of format 1_0, 1_3, 1_1 and/or 1_2 with or without DL assignment, an uplink DCI of format 0_0, 0_3, 0_1 and/or 0_2 with or without UL grant, or a dedicated DCI format for TCI state(s) indication, switching and/or update and/or etc. For instance, the NWR could be indicated in/via/by the DCI as in Step-2 of Mode A and/or Mode C as specified/defined herein in the present disclosure, and the NWR could be in form of:
a one-bit (ACK/NACK) indicator which can be set to ‘1’ or ‘0’
one or more indicators to activate and/or trigger and/or deactivate transmission(s) of one or more RSs, which could correspond to the one or more of the measurement RS resources requested or indicated or initiated or triggered by the one or more (second) indicators sent or transmitted by/in (part of) the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B for activation and/or deactivation according to or following those specified/defined herein in the present disclosure.

The NWR could be indicated by e.g. a/the CSI request field in the corresponding DCI format(s) e.g. 0_1/0_2; alternatively, the NWR could correspond to a dedicated/new DCI field in the corresponding DCI format(s), or optionally the NWR could be realized or implemented in the corresponding DCI format(s) by repurposing one or more codepoints of one or more existing DCI fields. The UE could receive, monitor, assess and/or measure the one or more RSs activated and/or triggered by the network,
no earlier than Y1′ symbol(s)/slot(s) and/or no later than Y2′ symbol(s)/slot(s) after a/the last (or first) symbol/slot/etc. of receiving or reception of the NWR, and/or
starting from a/the first symbol/slot/etc. that is at least Y3′ symbol(s)/slot(s) after a/the last (or first) symbol/slot/etc. of receiving or reception of the NWR.

The UE could determine or identify value(s) of Y1′, Y2′ and/or Y3′ according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, for Mode A, Mode B and/or Mode C, the UE could send or transmit a first message (or equivalently a PN message/trigger or a UEITI) by/in/on one or more PUCCHs/PUCCH resources of the first UL channel as in Step-1 to indicate one or more of (L≥1) RS resource configurations (e.g., higher layer provided or configured to the UE by CSI-ResourceConfigs, CSI-ResourceSets, NZP-CSI-RS-ResourceSets and/or etc.) for UE-initaited/event-driven beam operations, wherein a RS resource configuration could comprise one or more of:
a (candidate) periodicity for the measurement RS(s)/RS resource(s),
a (candidate) time offset for the measurement RS(s)/RS resource(s),
a (one-bit) indicator to indicate whether to increase or decrease periodicity for the measurement RS(s)/RS resource(s),
a delta value for increasing or decreasing periodicity for the measurement RS(s)/RS resource(s), and
resource ID(s)/index(es) of the measurement RS(s)/RS resource(s),
wherein the UE could determine or identify the measurement RS resources according to or based on or as one or more of:
the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.
More specifically, the first message could be in form of or could correspond to one or more of:
a one-bit indicator: for L=2 RS resource configurations, when/if the one-bit indicator is set to ‘1’ (or ‘0’), the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated; and/or when/if the one-bit indicator is set to ‘0’ (or ‘1’), the second RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
ak-bit (k≥1) indicator: in this case, k=[log₂ L]; when/if the first codepoint of the k-bit indicator is indicated, the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, when/if the second codepoint of the k-bit indicator is indicated, the second RS resource configuration or the RS resource configuration with the second lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, and so on, and/or when/if the last RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
a bitmap: for instance, the bitmap could be of length L with each entry/bit position corresponding, associated or specific to one of the L RS resource configurations; when/if an entry/bit position of the bitmap is set to ‘1’ (or ‘0’), the RS resource configuration-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-associated, corresponding or specific to the entry/bit position could be indicated;
a PUCCH/PUCCH resource with k (sequence) cyclic shift(s): for example, for k=L, when/if the first cyclic shift is used for transmitting the first message, the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, when/if the second cyclic shift is used for transmitting the first message, the second RS resource configuration or the RS resource configuration with the second lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, and so on, and/or when/if the last (or L-th) cyclic shift is used for transmitting the first message, the last (or L-th) RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated.

According to or following those specified herein in the present disclosure, for Mode A, Mode B and/or Mode C, the UE could send or transmit one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B to carry or convey one or more indicators to indicate one or more of (L≥1) RS resource configurations (e.g., higher layer provided or configured to the UE by CSI-ResourceConfigs, CSI-ResourceSets, NZP-CSI-RS-ResourceSets and/or etc.) for UE-initaited/event-driven beam operations, wherein a RS resource configuration could comprise one or more of:
a (candidate) periodicity for the measurement RS(s)/RS resource(s),
a (candidate) time offset for the measurement RS(s)/RS resource(s),
a (one-bit) indicator to indicate whether to increase or decrease periodicity for the measurement RS(s)/RS resource(s),
a delta value for increasing or decreasing periodicity for the measurement RS(s)/RS resource(s), and
resource ID(s)/index(es) of the measurement RS(s)/RS resource(s), wherein the UE could determine or identify the measurement RS resources according to or based on or as one or more of:
the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.

More specifically, the aforementioned one or more indicators conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to or could comprise one or more of:
a one-bit indicator: for L=2 RS resource configurations, when/if the one-bit indicator is set to ‘1’ (or ‘0’), the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated; and/or when/if the one-bit indicator is set to ‘0’ (or ‘1’), the second RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
one or more one-bit indicators: in this case, each of the one or more one-bit indicators could be associated, corresponding or specific to one of the L RS resource configurations; when/if a/the k-th (k belongs to {1, . . . , L}) one-bit indicator is set to ‘1’ (or ‘0’), the k-th RS resource configuration or the RS resource configuration with the k-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, and/or when/if the k-th one-bit indicator is set to ‘0’ (or ‘1’), the k-th RS resource configuration or the RS resource configuration with the k-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein—may not be indicated;
ak-bit (k≥1) indicator: in this case, k=[log₂ L]; when/if the first codepoint of the k-bit indicator is indicated, the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, when/if the second codepoint of the k-bit indicator is indicated, the second RS resource configuration or the RS resource configuration with the second lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, and so on, and/or when/if the last RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
one or more k-bit (k≥1) indicators: in this case, fork=[log₂L], when/if a k-bit indicator is set to a codepoint of the k-bit indicator corresponding to an index value k′ (k′ belongs to {1, . . . , L}), the k′-th RS resource configuration or the RS resource configuration with the k′-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, and/or when/if a k-bit indicator is set to a codepoint of the k-bit indicator corresponding to an index value k′, the k-th RS resource configuration or the RS resource configuration with the k-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein—may not be indicated;
a bitmap: for instance, the bitmap could be of length L with each entry/bit position corresponding, associated or specific to one of the L RS resource configurations; when/if an entry/bit position of the bitmap is set to ‘1’ (or ‘0’), the RS resource configuration-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-associated, corresponding or specific to the entry/bit position could be indicated;
one or more RS resource configuration IDs/indexes: for instance, the RS resource configuration(s)—out of all the L RS resource configurations-corresponding to the one or more RS resource configuration IDs/indexes or having the same RS resource configuration ID(s)/index(es) as the one or more RS resource configuration IDs/indexes (hence the (candidate) periodicity(s) for the measurement RS(s)/RS resource(s) or the (one-bit) indicator(s) set to ‘1’ (or ‘0’) indicating increasing (or decreasing) the periodicity(s) of the measurement RS(s)/RS resource(s) by the delta value(s) comprised or provided or configured therein) could be indicated.

According to or following those specified herein in the present disclosure, for Mode A, Mode B and/or Mode C, the UE could send or transmit a first message (or equivalently a PN message/trigger or a UEITI) by/in/on one or more PUCCHs/PUCCH resources of the first UL channel as in Step-1 to indicate to the network whether one or more of the (L≥1) RS resource configurations indicated by one or more indicators carried or conveyed by/in (part of) one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be indicated (or not indicated), wherein a RS resource configuration could comprise one or more of:
a (candidate) periodicity for the measurement RS(s)/RS resource(s), a (candidate) time offset for the measurement RS(s)/RS resource(s),
a (one-bit) indicator to indicate whether to increase or decrease periodicity for the measurement RS(s)/RS resource(s),
a delta value for increasing or decreasing periodicity for the measurement RS(s)/RS resource(s), and resource ID(s)/index(es) of the measurement RS(s)/RS resource(s)
and the UE could determine or identify the measurement RS resources according to or based on or as one or more of:
the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.

In this case, the first message could be in form of or could correspond to one or more of:
a one-bit indicator: in this case, when/if the one-bit indicator is set to ‘1’ (or ‘0’), the one or more of the RS resource configurations indicated by the one or more indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be indicated, and/or when/if the one-bit indicator is set to ‘0’ (or ‘1’), the one or more of the RS resource configurations indicated by the one or more indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B may not be indicated;
a PUCCH/PUCCH resource with two (sequence) cyclic shift(s): in this case, when/if the first cyclic shift is used for transmitting the first message, the one or more of the RS resource configurations indicated by the one or more indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be indicated, and/or when/if the second cyclic shift is used for transmitting the first message, the one or more of the RS resource configurations indicated by the one or more indicators carried or conveyed by/in (part of) the one or more second messages (or equivalently the UEI report content(s)/quantity(s)) transmitted or sent by/in/on one or more PUSCHs/PUSCH resources of the second UL channel as in Step-3 of Mode-A and/or Mode-C and/or Step-2 of Mode B may not be indicated.

The aforementioned one or more indicators conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to or could comprise one or more of:
a one-bit indicator: for L=2 RS resource configurations, when/if the one-bit indicator is set to ‘1’ (or ‘0’), the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated; and/or when/if the one-bit indicator is set to ‘0’ (or ‘1’), the second RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
one or more one-bit indicators: in this case, each of the one or more one-bit indicators could be associated, corresponding or specific to one of the L RS resource configurations; when/if a/the k-th (k belongs to {1, . . . , L}) one-bit indicator is set to ‘1’ (or ‘0’), the k-th RS resource configuration or the RS resource configuration with the k-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated or may not be indicated;
ak-bit (k≥1) indicator: in this case, k=[log₂ L]; when/if the first codepoint of the k-bit indicator is indicated, the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, when/if the second codepoint of the k-bit indicator is indicated, the second RS resource configuration or the RS resource configuration with the second lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, and so on, and/or when/if the last RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
one or more k-bit (k≥1) indicators: in this case, fork=[log₂L], when/if a k-bit indicator is set to a codepoint of the k-bit indicator corresponding to an index value k′ (k′ belongs to {1, . . . , L}), the k′-th RS resource configuration or the RS resource configuration with the k′-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated or may not be indicated;
a bitmap: for instance, the bitmap could be of length L with each entry/bit position corresponding, associated or specific to one of the L RS resource configurations; when/if an entry/bit position of the bitmap is set to ‘1’ (or ‘0’), the RS resource configuration-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-associated, corresponding or specific to the entry/bit position could be indicated or may not be indicated;
one or more RS resource configuration IDs/indexes: for instance, the RS resource configuration(s)—out of all the L RS resource configurations-corresponding to the one or more RS resource configuration IDs/indexes or having the same RS resource configuration ID(s)/index(es) as the one or more RS resource configuration IDs/indexes (hence the (candidate) periodicity(s) for the measurement RS(s)/RS resource(s) or the (one-bit) indicator(s) set to ‘1’ (or ‘0’) indicating increasing (or decreasing) the periodicity(s) of the measurement RS(s)/RS resource(s) by the delta value(s) comprised or provided or configured therein) could be indicated or may not be indicated.

According to or following those specified herein in the present disclosure, for Mode A, Mode B and/or Mode C, the UE could send or transmit one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B to carry or convey one or more first indicators (e.g., in part 1 of a two-part UCI/CSI) to indicate to the network whether one or more of the (L≥1) RS resource configurations indicated by one or more second indicators (e.g., in part 2 of a two-part UCI/CSI) carried or conveyed by/in (part of) the (same) one or more second messages (or equivalently the (same) UEI report content(s)/quantity(s)) sent or transmitted by/in/on the one or more PUSCHs/PUSCH resources of the second UL channel as in Step-3 of Mode-A and/or Mode-C and/or Step-2 of Mode B could be indicated (or not indicated), wherein a RS resource configuration could comprise one or more of:
a (candidate) periodicity for the measurement RS(s)/RS resource(s),
a (candidate) time offset for the measurement RS(s)/RS resource(s),
a (one-bit) indicator to indicate whether to increase or decrease periodicity for the measurement RS(s)/RS resource(s),
a delta value for increasing or decreasing periodicity for the measurement RS(s)/RS resource(s), and resource ID(s)/index(es) of the measurement RS(s)/RS resource(s)
and the UE could determine or identify the measurement RS resources according to or based on or as one or more of: the candidate/new beam RS(s) or RS resource(s) as specified or defined herein in the present disclosure, e.g., periodically configured or provided to the UE in one or more RS resource sets;
the current serving beam RS(s) or RS resource(s) as specified or defined herein in the present disclosure, e.g., the periodic CSI-RS(s)/SSB(s) associated or specific to the indicated TCI state(s) according to or following those specified herein in the present disclosure; and
one or more sets of RS resource(s) corresponding to (periodic) CSI-RS resource configuration(s) and/or SSB(s)—e.g. in terms/form of the corresponding RS/resource ID(s)/index(es)—provided or configured to the UE for the UE-initiated/event-driven beam operations.

In this case, the aforementioned one or more first indicators (e.g., in part 1 of a two-part UCI/CSI) conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to one or more of:
a one-bit indicator: in this case, when/if the one-bit indicator is set to ‘1’ (or ‘0’), the one or more of the RS resource configurations indicated by the one or more second indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be indicated, and/or when/if the one-bit indicator is set to ‘0’ (or ‘1’), the one or more of the RS resource configurations indicated by the one or more second indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B may not be indicated;
a PUCCH/PUCCH resource with two (sequence) cyclic shift(s): in this case, when/if the first cyclic shift is used for transmitting the first message, the one or more of the RS resource configurations indicated by the one or more second indicators carried or conveyed by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B could be indicated, and/or when/if the second cyclic shift is used for transmitting the first message, the one or more of the RS resource configurations indicated by the one or more second indicators carried or conveyed by/in (part of) the one or more second messages (or equivalently the UEI report content(s)/quantity(s)) transmitted or sent by/in/on one or more PUSCHs/PUSCH resources of the second UL channel as in Step-3 of Mode-A and/or Mode-C and/or Step-2 of Mode B may not be indicated.

The aforementioned one or more second indicators (e.g., in part 2 of the two-part UCI/CSI) conveyed or carried in (part of) the second message(s) or the UEI report content(s)/quantity(s) transmitted, sent or reported by/in/via/over/on the (DG or CG) PUSCH(s)/PUSCH resource(s) of the second UL channel could be in form of or could correspond to or could comprise one or more of:
a one-bit indicator: for L=2 RS resource configurations, when/if the one-bit indicator is set to ‘1’ (or ‘0’), the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated; and/or when/if the one-bit indicator is set to ‘0’ (or ‘1’), the second RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
one or more one-bit indicators: in this case, each of the one or more one-bit indicators could be associated, corresponding or specific to one of the L RS resource configurations; when/if a/the k-th (k belongs to {1, . . . , L}) one-bit indicator is set to ‘1’ (or ‘0’), the k-th RS resource configuration or the RS resource configuration with the k-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated or may not be indicated;
ak-bit (k≥1) indicator: in this case, k=[log₂ L]; when/if the first codepoint of the k-bit indicator is indicated, the first RS resource configuration or the RS resource configuration with the lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, when/if the second codepoint of the k-bit indicator is indicated, the second RS resource configuration or the RS resource configuration with the second lowest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated, and so on, and/or when/if the last RS resource configuration or the RS resource configuration with the highest resource configuration ID/index—e.g., comprising or providing or configuring a (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated;
one or more k-bit (k≥1) indicators: in this case, for k=[log₂L], when/if a k-bit indicator is set to a codepoint of the k-bit indicator corresponding to an index value k′ (k′ belongs to {1, . . . , L}), the k′-th RS resource configuration or the RS resource configuration with the k′-th lowest resource configuration ID/index-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-could be indicated or may not be indicated;
a bitmap: for instance, the bitmap could be of length L with each entry/bit position corresponding, associated or specific to one of the L RS resource configurations; when/if an entry/bit position of the bitmap is set to ‘1’ (or ‘0’), the RS resource configuration-hence the (candidate) periodicity for the measurement RS(s)/RS resource(s) or the (one-bit) indicator set to ‘1’ (or ‘0’) indicating increasing (or decreasing) the periodicity of the measurement RS(s)/RS resource(s) by the delta value comprised or provided or configured therein-associated, corresponding or specific to the entry/bit position could be indicated or may not be indicated;
one or more RS resource configuration IDs/indexes: for instance, the RS resource configuration(s)—out of all the L RS resource configurations-corresponding to the one or more RS resource configuration IDs/indexes or having the same RS resource configuration ID(s)/index(es) as the one or more RS resource configuration IDs/indexes (hence the (candidate) periodicity(s) for the measurement RS(s)/RS resource(s) or the (one-bit) indicator(s) set to ‘1’ (or ‘0’) indicating increasing (or decreasing) the periodicity(s) of the measurement RS(s)/RS resource(s) by the delta value(s) comprised or provided or configured therein) could be indicated or may not be indicated.

The UE could expect to receive a response from the network to the one or more (first) indicators sent or transmitted by/in (part of) the first message (or equivalently a PN message/trigger or a UEITI) sent or transmitted by/in/on one or more PUCCHs/PUCCH resources of the first UL channel as in Step-1, if any,
no earlier than X1 symbol(s)/slot(s) and/or no later than X2 symbol(s)/slot(s) after a/the last (or first) symbol/slot/etc. of transmitting or transmission(s) of the first message (or equivalently a PN message/trigger or a UEITI) by/in/on one or more PUCCHs/PUCCH resources of the first UL channel as in Step-1, and/or
starting from a/the first symbol/slot/etc. that is at least X3 symbol(s)/slot(s) after a/the last (or first) symbol/slot/etc. of transmitting or transmission(s) of the first message (or equivalently a PN message/trigger or a UEITI) by/in/on one or more PUCCHs/PUCCH resources of the first UL channel as in Step-1.

The UE could determine or identify value(s) of X1, X2 and/or X3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the NWR could be provided or configured or indicated by the network in form of RRC signaling(s)/parameter(s) and/or MAC CE command(s) and/or dynamic DCI based L1 signaling(s) based on or according to corresponding UE's capability(s) or capability signaling(s). When/if the NWR is indicated in/via/by a DCI based L1 signaling, the corresponding DCI can be a downlink DCI of format 1_0, 1_3, 1_1 and/or 1_2 with or without DL assignment, an uplink DCI of format 0_0, 0_3, 0_1 and/or 0_2 with or without UL grant, or a dedicated DCI format for TCI state(s) indication, switching and/or update and/or etc. For instance, the NWR could be indicated in/via/by the DCI as in Step-2 of Mode A and/or Mode C as specified/defined herein in the present disclosure, and the NWR could be in form of:
a one-bit (ACK/NACK) indicator which can be set to ‘l’ or ‘0’
one or more indicators to activate and/or trigger and/or deactivate transmission(s) of one or more RSs, which could have or could be configured/provided with/by the same RS resource configuration(s) requested or indicated or initiated or triggered by the one or more (first) indicators sent or transmitted by/in (part of) the first message (or equivalently a PN message/trigger or a UEITI) by/in/on one or more PUCCHs/PUCCH resources of the first UL channel as in Step-1 according to or following those specified/defined herein in the present disclosure.

The NWR could be indicated by e.g. a/the CSI request field in the corresponding DCI format(s) e.g. 0_1/0_2; alternatively, the NWR could correspond to a dedicated/new DCI field in the corresponding DCI format(s), or optionally the NWR could be realized or implemented in the corresponding DCI format(s) by repurposing one or more codepoints of one or more existing DCI fields. The UE could receive, monitor, assess and/or measure the one or more RSs activated and/or triggered by the network,
no earlier than Y1 symbol(s)/slot(s) and/or no later than Y2 symbol(s)/slot(s) after a/the last (or first) symbol/slot/etc. of receiving or reception of the NWR, and/or
starting from a/the first symbol/slot/etc. that is at least Y3 symbol(s)/slot(s) after a/the last (or first) symbol/slot/etc. of receiving or reception of the NWR,
and according to or based on the RS resource configuration(s)—hence the (candidate) periodicity for the measurement RS(s)/RS resource(s) comprised or provided or configured therein and/or determined or identified based on or according to the (one-bit) indicator set to ‘1’ (or ‘0’) indicating increasing (or decreasing) the periodicity of the measurement RS(s)/RS resource(s) by the delta value comprised or provided or configured therein-requested or indicated or initiated or triggered by the one or more (first) indicators sent or transmitted by/in (part of) the first message (or equivalently a PN message/trigger or a UEITI) by/in/on one or more PUCCHs/PUCCH resources of the first UL channel as in Step-1 according to or following those specified/defined herein in the present disclosure. The UE could determine or identify value(s) of Y1, Y2 and/or Y3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could expect to receive a response from the network to the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B, if any,
no earlier than X1′ symbol(s)/slot(s) and/or no later than X2′ symbol(s)/slot(s) after a/the last (or first) symbol/slot/etc. of transmitting or transmission(s) of the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B, and/or
starting from a/the first symbol/slot/etc. that is at least X3′ symbol(s)/slot(s) after a/the last (or first) symbol/slot/etc. of transmitting or transmission(s) of the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B.

The UE could determine or identify value(s) of X1′, X2′ and/or X3′ according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the NWR could be provided or configured or indicated by the network in form of RRC signaling(s)/parameter(s) and/or MAC CE command(s) and/or dynamic DCI based L1 signaling(s) based on or according to corresponding UE's capability(s) or capability signaling(s). When/if the NWR is indicated in/via/by a DCI based L1 signaling, the corresponding DCI can be a downlink DCI of format 1_0, 1_3, 1_1 and/or 1_2 with or without DL assignment, an uplink DCI of format 0_0, 0_3, 0_1 and/or 0_2 with or without UL grant, or a dedicated DCI format for TCI state(s) indication, switching and/or update and/or etc. For instance, the NWR could be indicated in/via/by the DCI as in Step-2 of Mode A and/or Mode C as specified/defined herein in the present disclosure, and the NWR could be in form of:
a one-bit (ACK/NACK) indicator which can be set to ‘1’ or ‘0’
one or more indicators to activate and/or trigger and/or deactivate transmission(s) of one or more RSs, which could have or could be configured/provided with/by the same RS resource configuration(s) requested or indicated or initiated or triggered by the one or more (second) indicators sent or transmitted by/in (part of) the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B according to or following those specified/defined herein in the present disclosure.

The NWR could be indicated by e.g. a/the CSI request field in the corresponding DCI format(s) e.g. 0_1/0_2; alternatively, the NWR could correspond to a dedicated/new DCI field in the corresponding DCI format(s), or optionally the NWR could be realized or implemented in the corresponding DCI format(s) by repurposing one or more codepoints of one or more existing DCI fields. The UE could receive, monitor, assess and/or measure the one or more RSs activated and/or triggered by the network,
no earlier than Y1′ symbol(s)/slot(s) and/or no later than Y2′ symbol(s)/slot(s) after a/the last (or first) symbol/slot/etc. of receiving or reception of the NWR, and/or
starting from a/the first symbol/slot/etc. that is at least Y3′ symbol(s)/slot(s) after a/the last (or first) symbol/slot/etc. of receiving or reception of the NWR,
according to or based on the RS resource configuration(s)—hence the (candidate) periodicity for the measurement RS(s)/RS resource(s) comprised or provided or configured therein and/or determined or identified based on or according to the (one-bit) indicator set to ‘1’ (or ‘0’) indicating increasing (or decreasing) the periodicity of the measurement RS(s)/RS resource(s) by the delta value comprised or provided or configured therein-requested or indicated or initiated or triggered by the one or more (second) indicators sent or transmitted by/in (part of) the one or more (second) indicators sent or transmitted by/in (part of) the one or more second messages (or equivalently the UEI report content(s)/quantity(s)) sent or transmitted by/in/on one or more PUSCHs/PUSCH resources of the second UL channel as in Step-3 of Mode-A and/or Mode-C and/or Step-2 of Mode B according to or following those specified/defined herein in the present disclosure. The UE could determine or identify value(s) of Y1′, Y2′ and/or Y3′ according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

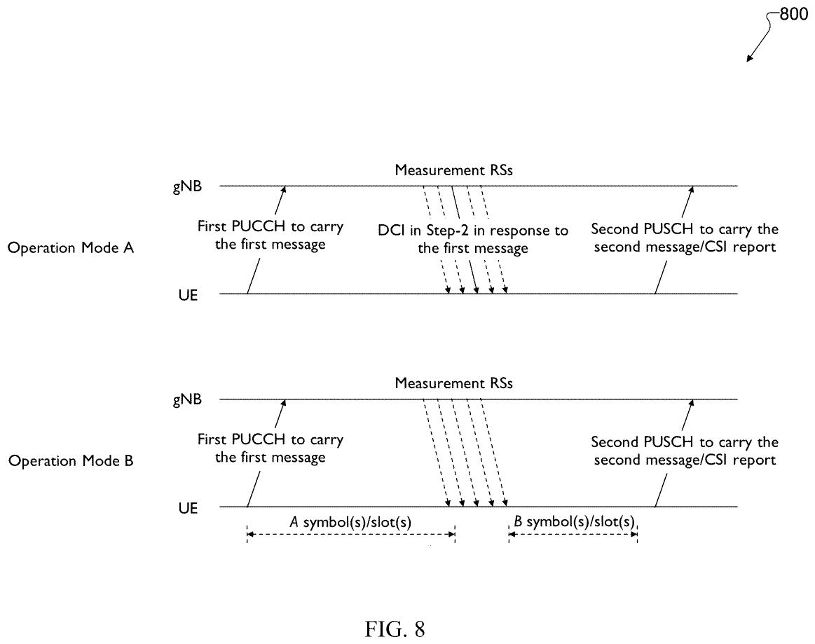

FIG. 8 illustrates an example of UE-initiated measurement RS(s) transmission for CSI measurement/reporting 800 according to embodiments of the present disclosure. For example, the CSI measurement/reporting shown in FIG. 8 can be followed by the UE 116 of FIG. 3. This example is for illustration only and other embodiments can be used without departing from the scope of the present disclosure.

According to or following those specified herein in the present disclosure, for Mode A, Mode B and/or Mode C, the UE could send or transmit a first message (or equivalently a PN message/trigger or a UEITI) by/in/on one or more PUCCHs/PUCCH resources of the first UL channel as in Step-1 to trigger or initiate transmission(s) of one or more measurement RSs for CSI measurement and reporting (as specified/defined herein in the present disclosure, the first message here could in addition to indicate a potential transmission of the second message(s)/CSI report(s) associated/specific to the first message as in Mode B, and/or request UL resource allocation and/or indication for a second UL channel that could carry or convey the second message(s)/CSI report(s) as in Mode A/C).
For Mode A and/or Mode C as specified/defined herein in the present disclosure, after the UE has sent or transmitted the first message
   In one example, the UE could expect to receive, measure and/or monitor the one or more measurement RSs no earlier than X1 symbol(s)/slot(s) and/or no later than X2 symbol(s)/slot(s) after a/the last (or first) symbol/slot/etc. of the PUCCH/PUCCH resource/PUCCH transmission occasion of the first UL channel used to transmit or send the first message.
   In another example, the UE could expect to receive, measure and/or monitor the one or more measurement RSs starting from a/the first symbol/slot/etc. that is at least X3 symbol(s)/slot(s) after a/the last (or first) symbol/slot/etc. of the PUCCH/PUCCH resource/PUCCH transmission occasion(s) of the first UL channel used to transmit or send the first message.
   In another example, the UE could expect to receive, measure and/or monitor the one or more measurement RSs at/in the same (or first) slot/symbol/etc. as that the UE receives or would expect to receive the DCI in response to the first message as in Step-2.
   In another example, the UE could expect to receive, measure and/or monitor the one or more measurement RSs no earlier than Y1 symbol(s)/slot(s) and/or no later than Y2 symbol(s)/slot(s) before a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs starting from a/the first symbol/slot/etc. that is at least Y3 symbol(s)/slot(s) before a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs no earlier than Y1′ symbol(s)/slot(s) and/or no later than Y2′ symbol(s)/slot(s) after a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs starting from a/the first symbol/slot/etc. that is at least Y3′ symbol(s)/slot(s) after a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs at/in the same (or first) slot(s)/symbol(s)/etc. as that/those the UE transmits or would expect to transmit the second message(s)/CSI report(s) via/in/by/on/over the PUSCH(s)/PUSCH resource(s)/PUSCH TO(s) of the second UL channel.
   In another example, the UE could expect to receive, measure and/or monitor the one or more measurement RSs no earlier than Z1 symbol(s)/slot(s) and/or no later than Z2 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s).
   In another example, the UE could expect to receive, measure and/or monitor the one or more measurement RSs starting from a/the first symbol/slot/etc. that is at least Z3 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s).

For the above described design example(s), the one or more measurement RSs could correspond to that/those triggered or initiated or provided or indicated by the DCI in Step-2 (i.e., the aperiodic CSI-RS(s) for channel measurement); furthermore, the second message(s) transmitted or sent in/by/over/on the PUSCH(s)/PUSCH resource(s)/PUSCH TO(s) of the second UL channel could be corresponding or specific to or for the first message transmitted or sent via/in/by/over/on the PUCCH/PUCCH resource/PUCCH TO of the first UL channel according to or following those specified/defined herein in the present disclosure. The UE could determine or identify value(s) of X1, X2, X3, Y1, Y2, Y3, Y1′, Y2′, Y3′, Z1, Z2 and/or Z3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
For Mode B as specified/defined herein in the present disclosure,
   In one example, the UE could expect to receive, measure and/or monitor the one or more measurement RSs no earlier than A1 symbol(s)/slot(s) and/or no later than A2 symbol(s)/slot(s) after a/the last (or first) symbol/slot/etc. of the PUCCH/PUCCH resource/PUCCH transmission occasion of the first UL channel used to transmit or send the first message
   In another example, the UE could expect to receive, measure and/or monitor the one or more measurement RSs starting from a/the first symbol/slot/etc. that is at least A3 symbol(s)/slot(s) after a/the last (or first) symbol/slot/etc. of the PUCCH/PUCCH resource/PUCCH transmission occasion of the first UL channel used to transmit or send the first message
   In another example, the UE could expect to receive, measure and/or monitor the one or more measurement RSs at/in the same (or first) slot(s)/symbol(s)/etc. as that/those the UE transmits or would expect to transmit the second message(s)/CSI report(s) via/in/by/on/over the PUSCH(s)/PUSCH resource(s)/PUSCH TO(s) of the second UL channel that is (i) mapped or linked or associated to the PUCCH/PUCCH resource/PUCCH TO of the first UL channel according to or based on network's higher layer RRC signaling(s)/parameter(s)/configuration(s) and/or (ii) available and/or valid for transmitting or sending the second message(s)/CSI report(s)—e.g., not overlapping with other DL/UL channel(s)/signal(s), wherein the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message.
   In another example, the UE could expect to receive, measure and/or monitor the one or more measurement RSs no earlier than B1 symbol(s)/slot(s) and/or no later than B2 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s) that is (i) mapped or linked or associated to the PUCCH/PUCCH resource/PUCCH TO of the first UL channel according to or based on network's higher layer RRC signaling(s)/parameter(s)/configuration(s) and/or (ii) available and/or valid for transmitting or sending the second message(s)/CSI report(s)—e.g., not overlapping with other DL/UL channel(s)/signal(s), wherein the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message.
   In another example, the UE could expect to receive, measure and/or monitor the one or more measurement RSs starting from a/the first symbol/slot/etc. that is at least B3 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s) that is (i) mapped or linked or associated to the PUCCH/PUCCH resource/PUCCH TO of the first UL channel according to or based on network's higher layer RRC signaling(s)/parameter(s)/configuration(s) and/or (ii) available and/or valid for transmitting or sending the second message(s)/CSI report(s)—e.g., not overlapping with other DL/UL channel(s)/signal(s), wherein the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message.

For the above described design examples, according to or following those specified herein in the present disclosure, the UE could determine or identify the PUSCH(s)/PUSCH resource(s)/PUSCH TO(s) of the second UL channel to transmit or send the second message(s)/CSI report(s) according to or following one or more of:
the PUSCH(s)/PUSCH resource(s)/PUSCH TO(s) of the second UL channel could be mapped or linked or associated to the PUCCH/PUCCH resource/PUCCH TO of the first UL channel according to or based on network's higher layer RRC signaling(s)/parameter(s)/configuration(s);
the PUSCH(s)/PUSCH resource(s)/PUSCH TO(s) of the second UL channel could be available and/or valid for transmitting or sending the second message(s)/CSI report(s)—e.g., not overlapping with other DL/UL channel(s)/signal(s);
the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message;
(the first (or last) symbol/slot/etc. of) the PUSCH(s)/PUSCH resource(s)/PUSCH TO(s) of the second UL channel could be at/in a/the same slot/symbol/etc. as that (e.g., a/the last (or first) symbol/slot/etc.) of receiving/measuring/monitoring or reception(s) of the one or more measurement RSs;
the first (or last) symbol/slot/etc. of the PUSCH(s)/PUSCH resource(s)/PUSCH TO(s) of the second UL channel could be no earlier than C1 symbol(s)/slot(s) and/or no later than C2 symbol(s)/slot(s) after a/the last (or first) symbol/slot/etc. of receiving/measuring/monitoring or reception(s) of the one or more measurement RSs;
the first (or last) symbol/slot/etc. of the PUSCH(s)/PUSCH resource(s)/PUSCH TO(s) of the second UL channel could be starting from a/the first symbol/slot/etc. that is at least C3 symbol(s)/slot(s) after a/the last (or first) symbol/slot/etc. of receiving/measuring/monitoring or reception(s) of the one or more measurement RSs.

The UE could determine or identify value(s) of A1, A2, A3, B1, B2, B3, C1, C2, C3 and/or D according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

In FIG. 8, conceptual examples of the above described design procedures are presented for Mode A and Mode B.

According to or following those specified herein in the present disclosure, the UE could send or transmit a third message (or equivalently a PN message/trigger or a UEITI) only to trigger or initiate transmission(s) of one or more measurement RSs for CSI measurement and reporting, wherein the third message could be separately transmitted or sent from the first message such that they could be transmitted or sent over/in/by/on different or separate (periodic) PUCCHs or PUCCH resources or PUCCH TOs. In addition, configuration(s), format(s), resource allocation(s)/configuration(s) of or for transmitting or sending a third message could be the same as or identical to those of or for transmitting or sending a first message as specified/defined herein in the present disclosure. For instance, the third message is in form of a PN message/trigger or a UEITI as specified/defined herein in the present disclosure, a one-bit indicator/UCI, and transmitted/sent in/by/on/over one or more (periodic) PUCCHs or PUCCH resources or PUCCH TOs of PUCCH format(s) 0/1 provided, configured or dedicated for transmitting or sending the third message. Optionally, the UE could expect to receive from the network a DCI in response to a third message (or transmission(s) of the third message)
no earlier than K1 symbol(s)/slot(s) and/or no later than K2 symbol(s)/slot(s) after a/the first (or last) symbol/slot/etc. of the PUCCH/PUCCH resource/PUCCH TO used to transmit or send the third message, and/or
starting from a/the first symbol/slot/etc. that is at least K3 symbol(s)/slot(s) after a/the first (or last) symbol/slot/etc. of the PUCCH/PUCCH resource/PUCCH TO used to transmit or send the third message,
wherein the DCI in response to a third message could:
provide, indicate or comprise an (one-bit) ACK/NACK indicator in response to the third message or transmission(s) of the third message; for instance, when the (one-bit) indicator is set to ‘1’ (or ‘0’)—i.e., as an ACK, it could indicate to the UE that the network has successfully received or detected the third message; here, the (one-bit) indicator could be implemented or realized via/by a new/dedicated DCI field in the corresponding DCI format(s), and/or repurposing one or more codepoints of one or more existing DCI fields in the corresponding DCI format(s).
trigger or indicate the one or more measurement RSs for CSI measurement and/or reporting.

In this case, the UE could transmit or send a third message via/in/by/on/over one or more PUCCHs, PUCCH resources or PUCCH TOs, wherein the first (or last) symbol/slot/etc. of the third message and/or the corresponding one or more PUCCH, PUCCH resources or PUCCH TOs could be
in/at a/the same (or first) slot/symbol/etc. of the PUCCH/PUCCH resource/PUCCH TO used to transmit or send the first message
no earlier than K1 symbol(s)/slot(s) and/or no later than K2 symbol(s)/slot(s) after a/the first (or last) symbol/slot/etc. of the PUCCH/PUCCH resource/PUCCH TO used to transmit or send the first message, and/or
starting from a/the first symbol/slot/etc. that is at least K3 symbol(s)/slot(s) after a/the first (or last) symbol/slot/etc. of the PUCCH/PUCCH resource/PUCCH TO used to transmit or send the first message, and/or
no earlier than K1′ symbol(s)/slot(s) and/or no later than K2′ symbol(s)/slot(s) before a/the first (or last) symbol/slot/etc. of the PUCCH/PUCCH resource/PUCCH TO used to transmit or send the first message, and/or
starting from a/the first symbol/slot/etc. that is at least K3′ symbol(s)/slot(s) before a/the first (or last) symbol/slot/etc. of the PUCCH/PUCCH resource/PUCCH TO used to transmit or send the first message, and/or
in/at a/the same (or first) slot/symbol/etc. of receiving or reception of the PDCCH candidate(s) that carries or conveys the DCI in response to the first message as in Step-2 of Mode A/C, and/or
no earlier than L1 symbol(s)/slot(s) and/or no later than L2 symbol(s)/slot(s) after a/the first (or last) symbol/slot/etc. of receiving or reception of the PDCCH candidate(s) that carries or conveys the DCI in response to the first message as in Step-2 of Mode A/C, and/or
starting from a/the first symbol/slot/etc. that is at least L3 symbol(s)/slot(s) after a/the first (or last) symbol/slot/etc. of receiving or reception of the PDCCH candidate(s) that carries or conveys the DCI in response to the first message as in Step-2 of Mode A/C, and/or
no earlier than L1′ symbol(s)/slot(s) and/or no later than L2′ symbol(s)/slot(s) before a/the first (or last) symbol/slot/etc. of receiving or reception of the PDCCH candidate(s) that carries or conveys the DCI in response to the first message as in Step-2 of Mode A/C, and/or
starting from a/the first symbol/slot/etc. that is at least L3′ symbol(s)/slot(s) before a/the first (or last) symbol/slot/etc. of receiving or reception of the PDCCH candidate(s) that carries or conveys the DCI in response to the first message as in Step-2 of Mode A/C, and/or
in/at a/the same (or first) symbol/slot/etc. of the PUSCH(s)/PUSCH resource(s)/PUSCH TO(s) of the second UL channel used to transmit or send the second message(s)/CSI report(s) no earlier than M1 symbol(s)/slot(s) and/or no later than M2 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s), and/or
starting from a/the first symbol/slot/etc. that is at least M3 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s).

The UE could determine or identify value(s) of K1, K2, K3, L1, L2, L3, K1′, K2′, K3′, L1′, L2′, L3′, M1, M2 and/or M3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified/defined herein in the present disclosure, after the UE has sent or transmitted the third message only to trigger or initiate transmission(s) of one or more measurement RSs for CSI measurement and reporting
For Mode A and/or Mode C as specified/defined herein in the present disclosure,
   In one example, the UE could expect to receive, measure and/or monitor the one or more measurement RSs no earlier than P1 symbol(s)/slot(s) and/or no later than P2 symbol(s)/slot(s) after a/the last (or first) symbol/slot/etc. of the PUCCH/PUCCH resource/PUCCH transmission occasion used to transmit or send the third message.
   In another example, the UE could expect to receive, measure and/or monitor the one or more measurement RSs starting from a/the first symbol/slot/etc. that is at least P3 symbol(s)/slot(s) after a/the last (or first) symbol/slot/etc. of the PUCCH/PUCCH resource/PUCCH transmission occasion(s) used to transmit or send the third message.
   In another example, the UE could expect to receive, measure and/or monitor the one or more measurement RSs at/in the same (or first) slot/symbol/etc. as that the UE receives or would expect to receive the DCI in response to the third message.
   In another example, the UE could expect to receive, measure and/or monitor the one or more measurement RSs no earlier than Q1 symbol(s)/slot(s) and/or no later than Q2 symbol(s)/slot(s) before a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs starting from a/the first symbol/slot/etc. that is at least Q3 symbol(s)/slot(s) before a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs no earlier than Q1′ symbol(s)/slot(s) and/or no later than Q2′ symbol(s)/slot(s) after a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs starting from a/the first symbol/slot/etc. that is at least Q3′ symbol(s)/slot(s) after a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs at/in the same (or first) slot/symbol/etc. as that of the PUCCH/PUCCH resource/PUCCH transmission occasion of the first UL channel used to transmit or send the first message.
   In another example, the UE could expect to receive, measure and/or monitor the one or more measurement RSs no earlier than X1 symbol(s)/slot(s) and/or no later than X2 symbol(s)/slot(s) before a/the last (or first) symbol/slot/etc. of the PUCCH/PUCCH resource/PUCCH transmission occasion of the first UL channel used to transmit or send the first message.
   In another example, the UE could expect to receive, measure and/or monitor the one or more measurement RSs starting from a/the first symbol/slot/etc. that is at least X3 symbol(s)/slot(s) before a/the last (or first) symbol/slot/etc. of the PUCCH/PUCCH resource/PUCCH transmission occasion(s) of the first UL channel used to transmit or send the first message.
   In another example, the UE could expect to receive, measure and/or monitor the one or more measurement RSs no earlier than X1′ symbol(s)/slot(s) and/or no later than X2′ symbol(s)/slot(s) after a/the last (or first) symbol/slot/etc. of the PUCCH/PUCCH resource/PUCCH transmission occasion of the first UL channel used to transmit or send the first message.
   In another example, the UE could expect to receive, measure and/or monitor the one or more measurement RSs starting from a/the first symbol/slot/etc. that is at least X3′ symbol(s)/slot(s) after a/the last (or first) symbol/slot/etc. of the PUCCH/PUCCH resource/PUCCH transmission occasion(s) of the first UL channel used to transmit or send the first message.
   In another example, the UE could expect to receive, measure and/or monitor the one or more measurement RSs at/in the same (or first) slot as that the UE receives or would expect to receive the DCI as in Step-2 in response to the first message.
   In another example, the UE could expect to receive, measure and/or monitor the one or more measurement RSs no earlier than Y1 symbol(s)/slot(s) and/or no later than Y2 symbol(s)/slot(s) before a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs starting from a/the first symbol/slot/etc. that is at least Y3 symbol(s)/slot(s) before a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs no earlier than Y1′ symbol(s)/slot(s) and/or no later than Y2′ symbol(s)/slot(s) after a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs starting from a/the first symbol/slot/etc. that is at least Y3′ symbol(s)/slot(s) after a/the last (or first) symbol/slot/etc. of receiving or reception of the PDCCH candidate(s) that carries or conveys the DCI in Step-2 in response to the first message.
   In another example, the UE could expect to receive, measure and/or monitor the one or more measurement RSs at/in the same (or first) slot(s) as that/those the UE transmits or would expect to transmit the second message(s)/CSI report(s) via/in/by/on/over the PUSCH(s)/PUSCH resource(s)/PUSCH TO(s) of the second UL channel.
   In another example, the UE could expect to receive, measure and/or monitor the one or more measurement RSs no earlier than Z1 symbol(s)/slot(s) and/or no later than Z2 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s).
   In another example, the UE could expect to receive, measure and/or monitor the one or more measurement RSs starting from a/the first symbol/slot/etc. that is at least Z3 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s).

For the above described design example(s), the one or more measurement RSs could correspond to that/those triggered or initiated or provided or indicated by the DCI in response to the third message and/or the DCI in Step-2 in response to the first message (i.e., the aperiodic CSI-RS(s) for channel measurement); furthermore, the second message(s) transmitted or sent in/by/over/on the PUSCH(s)/PUSCH resource(s)/PUSCH TO(s) of the second UL channel could be corresponding or specific to or for the first message transmitted or sent via/in/by/over/on the PUCCH/PUCCH resource/PUCCH TO of the first UL channel according to or following those specified/defined herein in the present disclosure. The UE could determine or identify value(s) of P1, P2, P3, Q1, Q2, Q3, Q1′, Q2′, Q3′, X1, X2, X3, Y1, Y2, Y3, X1′, X2′, X3′, Y1′, Y2′, Y3′, Z1, Z2, and/or Z3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

For Mode B as specified/defined herein in the present disclosure,
   In one example, the UE could expect to receive, measure and/or monitor the one or more measurement RSs no earlier than P1 symbol(s)/slot(s) and/or no later than P2 symbol(s)/slot(s) after a/the last (or first) symbol/slot/etc. of the PUCCH/PUCCH resource/PUCCH transmission occasion used to transmit or send the third message.
   In another example, the UE could expect to receive, measure and/or monitor the one or more measurement RSs starting from a/the first symbol/slot/etc. that is at least P3 symbol(s)/slot(s) after a/the last (or first) symbol/slot/etc. of the PUCCH/PUCCH resource/PUCCH transmission occasion(s) used to transmit or send the third message.
   In another example, the UE could expect to receive, measure and/or monitor the one or more measurement RSs at/in the same (or first) slot/symbol/etc. as that the UE receives or would expect to receive the DCI in response to the third message.
   In another example, the UE could expect to receive, measure and/or monitor the one or more measurement RSs no earlier than Q1 symbol(s)/slot(s) and/or no later than Q2 symbol(s)/slot(s) before a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs starting from a/the first symbol/slot/etc. that is at least Q3 symbol(s)/slot(s) before a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs no earlier than Q1′ symbol(s)/slot(s) and/or no later than Q2′ symbol(s)/slot(s) after a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs starting from a/the first symbol/slot/etc. that is at least Q3′ symbol(s)/slot(s) after a/the last (or first) symbol/slot/etc. of receiving or reception of the PDCCH candidate(s) that carries or conveys the DCI in response to the third message.
   In another example, the UE could expect to receive, measure and/or monitor the one or more measurement RSs at/in the same (or first) slot/symbol/etc. as that of the PUCCH/PUCCH resource/PUCCH transmission occasion of the first UL channel used to transmit or send the first message.
   In another example, the UE could expect to receive, measure and/or monitor the one or more measurement RSs no earlier than A1 symbol(s)/slot(s) and/or no later than A2 symbol(s)/slot(s) before a/the last (or first) symbol/slot/etc. of the PUCCH/PUCCH resource/PUCCH transmission occasion of the first UL channel used to transmit or send the first message.
   In another example, the UE could expect to receive, measure and/or monitor the one or more measurement RSs starting from a/the first symbol/slot/etc. that is at least A3 symbol(s)/slot(s) before a/the last (or first) symbol/slot/etc. of the PUCCH/PUCCH resource/PUCCH transmission occasion(s) of the first UL channel used to transmit or send the first message.
   In another example, the UE could expect to receive, measure and/or monitor the one or more measurement RSs no earlier than A1′ symbol(s)/slot(s) and/or no later than A2′ symbol(s)/slot(s) after a/the last (or first) symbol/slot/etc. of the PUCCH/PUCCH resource/PUCCH transmission occasion of the first UL channel used to transmit or send the first message.
   In another example, the UE could expect to receive, measure and/or monitor the one or more measurement RSs starting from a/the first symbol/slot/etc. that is at least A3′ symbol(s)/slot(s) after a/the last (or first) symbol/slot/etc. of the PUCCH/PUCCH resource/PUCCH transmission occasion(s) of the first UL channel used to transmit or send the first message.
   In another example, the UE could expect to receive, measure and/or monitor the one or more measurement RSs at/in the same (or first) slot(s)/symbol(s)/etc. as that/those the UE transmits or would expect to transmit the second message(s)/CSI report(s) via/in/by/on/over the PUSCH(s)/PUSCH resource(s)/PUSCH TO(s) of the second UL channel that is (i) mapped or linked or associated to the PUCCH/PUCCH resource/PUCCH TO of the first UL channel according to or based on network's higher layer RRC signaling(s)/parameter(s)/configuration(s) and/or (ii) available and/or valid for transmitting or sending the second message(s)/CSI report(s)—e.g., not overlapping with other DL/UL channel(s)/signal(s), wherein the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message.
   In another example, the UE could expect to receive, measure and/or monitor the one or more measurement RSs no earlier than B1 symbol(s)/slot(s) and/or no later than B2 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s) that is (i) mapped or linked or associated to the PUCCH/PUCCH resource/PUCCH TO of the first UL channel according to or based on network's higher layer RRC signaling(s)/parameter(s)/configuration(s) and/or (ii) available and/or valid for transmitting or sending the second message(s)/CSI report(s)—e.g., not overlapping with other DL/UL channel(s)/signal(s), wherein the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message.
   In another example, the UE could expect to receive, measure and/or monitor the one or more measurement RSs starting from a/the first symbol/slot/etc. that is at least B3 symbol(s)/slot(s) before a/the first (or last) symbol/slot/etc. of the PUSCH(s)/PUSCH resource(s)/PUSCH TO(s) of the second UL channel used to transmit or send the second message(s)/CSI report(s) that is (i) mapped or linked or associated to the PUCCH/PUCCH resource/PUCCH TO of the first UL channel according to or based on network's higher layer RRC signaling(s)/parameter(s)/configuration(s) and/or (ii) available and/or valid for transmitting or sending the second message(s)/CSI report(s)—e.g., not overlapping with other DL/UL channel(s)/signal(s), wherein the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message.

For the above described design examples, according to or following those specified herein in the present disclosure, the UE could determine or identify the PUSCH(s)/PUSCH resource(s)/PUSCH TO(s) of the second UL channel to transmit or send the second message(s)/CSI report(s) according to or following one or more of:
the PUSCH(s)/PUSCH resource(s)/PUSCH TO(s) of the second UL channel could be mapped or linked or associated to the PUCCH/PUCCH resource/PUCCH TO of the first UL channel according to or based on network's higher layer RRC signaling(s)/parameter(s)/configuration(s);
the PUSCH(s)/PUSCH resource(s)/PUSCH TO(s) of the second UL channel could be available and/or valid for transmitting or sending the second message(s)/CSI report(s)—e.g., not overlapping with other DL/UL channel(s)/signal(s);
the first (or last) symbol/slot/etc. of the PUSCH(s)/PUSCH resource(s)/PUSCH TO(s) of the second UL channel could be at least D symbol(s)/slot(s)/etc. after the first (or last) symbol/slot/etc. of the PUCCH/PUCCH resource/PUCCH TO of the first UL channel used/applied for transmitting or sending the first message;
(the first (or last) symbol/slot/etc. of) the PUSCH(s)/PUSCH resource(s)/PUSCH TO(s) of the second UL channel could be at/in a/the same slot/symbol/etc. as that (e.g., a/the last (or first) symbol/slot/etc.) of receiving/measuring/monitoring or reception(s) of the one or more measurement RSs;
the first (or last) symbol/slot/etc. of the PUSCH(s)/PUSCH resource(s)/PUSCH TO(s) of the second UL channel could be no earlier than C1 symbol(s)/slot(s) and/or no later than C2 symbol(s)/slot(s) after a/the last (or first) symbol/slot/etc. of receiving/measuring/monitoring or reception(s) of the one or more measurement RSs;
the first (or last) symbol/slot/etc. of the PUSCH(s)/PUSCH resource(s)/PUSCH TO(s) of the second UL channel could be starting from a/the first symbol/slot/etc. that is at least C3 symbol(s)/slot(s) after a/the last (or first) symbol/slot/etc. of receiving/measuring/monitoring or reception(s) of the one or more measurement RSs.

The UE could determine or identify value(s) of P1, P2, P3, Q1, Q2, Q3, Q1′, Q2′, Q3′, A1, A2, A3, B1, B2, B3, A1′, A2′, A3′, C1, C2, C3 and/or D according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig and/or UEI-ReportConfig that provides or configures necessary information and/or resource and/or reporting setting(s) for the UE-initiated/event-driven beam operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Throughout the present disclosure, a PN message/trigger could be referred to as or could be equivalent to a UEITI or a UE-initiated request report (UEIRR), and they can be used in an exchangeable manner.

Throughout the present disclosure, transmitting or transmission(s) of or re-transmission(s) of a PUCCH of the first UL channel as in Step-1 of Mode A, Mode B and/or Mode C according to or following those specified/defined herein in the present disclosure could be equivalent to transmitting or transmission(s) of or re-transmission(s) of a PN message/trigger over/in/by a PUCCH resource of the first UL channel as in Step-1 of Mode A, Mode B and/or Mode C according to or following those specified/defined herein in the present disclosure. Similarly, transmitting, transmission(s) of or re-transmission(s) of beam report(s), e.g., the UEI beam report(s) as specified/defined herein in the present disclosure, via/by/in (DG or CG) PUSCH resource(s) of the second UL channel as in Step-2 of Mode B and/or Step-3 of Mode A and/or Mode C according to or following those specified/defined herein in the present disclosure is equivalent to transmitting, transmission(s) of or re-transmission(s) of PUSCH(s) or PUSCH resource(s) of the second UL channel as in Step-2 of Mode B and/or Step-3 of Mode A and/or Mode C carrying beam report(s), e.g., the UEI beam report(s) as specified/defined herein in the present disclosure, according to or following those specified/defined herein in the present disclosure. The UE could be provided or configured by the network, e.g., via higher layer RRC signalling(s)/parameter(s) e.g. firstPUCCHResourceConfig-UEIBR, a configuration for PUCCH transmission of the first UL channel as in Step-1 of Mode A, Mode B and/or Mode C with a/the report notification (RN) or report resource request (RRR), wherein a/the RN or RRR could be of a UCI type/parameter. Furthermore, the UE could be provided or configured by the network, e.g., via higher layer RRC signalling(s)/parameter(s) e.g. secondPUSCHResourceConfig-UEIBR, a configuration for PUSCH transmission of the second UL channel as in Step-2 of Mode B.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity-including SSBRI/CRI, L1-RSRP/L1-SINR and/or etc.—corresponding/associated/specific to a beam reported in a UEI (beam) report or a CSI report or a beam report in general, and/or one or more report contents/quantities-including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc. A/the higher layer parameter CSI-ReportConfig and/or UEI-ReportConfig could correspond to or could be equivalent to or referred to a/the higher layer parameter CSI-AssociatedReportConfigInfo, and vice versa, such that they could be used or applied exchangeably or in similar/same manner(s) throughout the present disclosure. Additionally, a CSI reporting setting not (dedicated) for the UE-initiated/event-driven beam reporting as specified/defined herein in the present disclosure could correspond to or could be equivalent to or could be referred to a CSI reporting setting for (legacy) aperiodic CSI/beam reporting or a CSI reporting setting for L1/L2 triggered mobility (LTM), and vice versa. In addition, a CSI reporting setting corresponding to another CSI reporting setting could be equivalent to the CSI reporting setting comprising, containing, including and/or providing the another CSI reporting setting.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s). Furthermore, a CSI report setting/CSI report configuration is equivalent to a CSI reporting setting/CSI reporting configuration and vice versa.

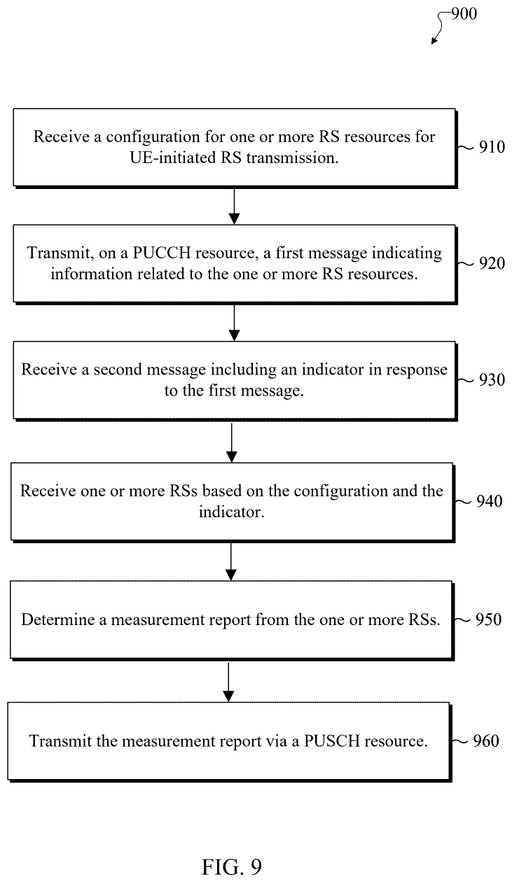

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 1900 begins with the UE receiving a configuration for one or more RS resources for UE-initiated RS transmission (910). The UE then transmits, on a PUCCH resource, a first message indicating information related to the one or more RS resources (920). In various embodiments, the configuration includes a RS resource setting for the one or more RS resources and the information includes a codepoint mapped to the RS resource setting.

The UE then receives a second message including an indicator in response to the first message (930). For example, the indicator is a one-bit acknowledgement or a codepoint mapped to a trigger state associated with the RS resource setting, and the one or more RSs correspond to the a subset of one or more RS resources. In various embodiments, the second message is a DCI, received within T_{offset} from an end of transmission of the first message, and T_{offset} is provided in the configuration. In various embodiments, the PUSCH resource starts no earlier than T_{gap} from an end of the PUCCH resource, and T_{gap} is provided in the configuration or indicated by the indicator.

The UE then receives one or more RSs based on the configuration and the indicator (940). In various embodiments, the one or more RSs are received within T_{proc} after reception of the second message, and T_{proc} is provided in the configuration. In various embodiments, the information includes a bitmap indicating a subset of the one or more RS resources, the indicator is a one-bit acknowledgement or a codepoint mapped to the subset, and the one or more RSs correspond to the subset.

The UE then determines a measurement report from the one or more RSs (950). The UE then transmit the measurement report via a PUSCH resource (960).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a configuration for one or more reference signal (RS) resources for UE-initiated RS transmission;
transmit, on a physical uplink control channel (PUCCH) resource, a first message indicating information related to the one or more RS resources;
receive, in response to the first message, a second message including an indicator; and
receive, based on the configuration and the indicator, one or more RSs; and
a processor operably coupled with the transceiver, the processor configured to determine a measurement report from the one or more RSs,
wherein the transceiver is further configured to transmit, via a physical uplink shared channel (PUSCH) resource, the measurement report.

2. The UE of claim 1, wherein:
the configuration includes a RS resource setting for the one or more RS resources; and
the information includes a codepoint mapped to the RS resource setting.

3. The UE of claim 2, wherein:
the indicator is one of:
a one-bit acknowledgement, or
a codepoint mapped to a trigger state associated with the RS resource setting; and
the one or more RSs correspond to a subset of the one or more RS resources.

4. The UE of claim 1, wherein the second message is:
a downlink control information (DCI);
received within a time duration (T_{offset}) from an end of transmission of the first message, and
the T_{offset} is provided in the configuration.

5. The UE of claim 1, wherein:
the PUSCH resource starts no earlier than a time game (T_{gap}) from an end of the PUCCH resource, and
the T_{gap} is provided in the configuration or indicated by the indicator.

6. The UE of claim 1, wherein:
the one or more RSs are received within a time duration (T_{proc}) after reception of the second message, and
the T_{proc} is provided in the configuration.

7. The UE of claim 1, wherein:
the information includes a bitmap indicating a subset of the one or more RS resources;
the indicator is one of:
a one-bit acknowledgement, or
a codepoint mapped to the subset; and
the one or more RSs correspond to the subset.

8. A base station (BS), comprising:
a processor; and
a transceiver operably coupled with the processor, the transceiver configured to:
transmit a configuration for one or more reference signal (RS) resources for user equipment (UE)-initiated RS transmission;
receive, on a physical uplink control channel (PUCCH) resource, a first message indicating information related to the one or more RS resources;
transmit, in response to the first message, a second message including an indicator;
transmit, based on the configuration and the indicator, one or more RSs; and
receive, via a physical uplink shared channel (PUSCH) resource, a measurement report,
wherein the measurement report is based on the one or more RSs.

9. The BS of claim 8, wherein:
the configuration includes a RS resource setting for the one or more RS resources; and
the information includes a codepoint mapped to the RS resource setting.

10. The BS of claim 9, wherein:
the indicator is one of:
a one-bit acknowledgement, or
a codepoint mapped to a trigger state associated with the RS resource setting; and
the one or more RSs correspond to the a subset of one or more RS resources.

11. The BS of claim 8, wherein the second message is:
a downlink control information (DCI);
transmitted within a time duration (T_{offset}) from an end of reception of the first message, and
the T_{offset} is provided in the configuration.

12. The BS of claim 8, wherein:
the PUSCH resource starts no earlier than a time game (T_{gap}) from an end of the PUCCH resource, and
the T_{gap} is provided in the configuration or indicated by the indicator.

13. The BS of claim 8, wherein:
the one or more RSs are transmitted within a time duration (T_{proc}) after transmission of the second message, and
the T_{proc} is provided in the configuration.

14. The BS of claim 8, wherein:
the information includes a bitmap indicating a subset of the one or more RS resources;
the indicator is one of:
a one-bit acknowledgement, or
a codepoint mapped to the subset; and
the one or more RSs correspond to the subset.

15. A method performed by a user equipment (UE), the method comprising:
receiving a configuration for one or more reference signal (RS) resources for UE-initiated RS transmission;
transmitting, on a physical uplink control channel (PUCCH) resource, a first message indicating information related to the one or more RS resources;
receiving, in response to the first message, a second message including an indicator;
receiving, based on the configuration and the indicator, one or more RSs;
determining a measurement report from the one or more RSs; and
transmitting, via a physical uplink shared channel (PUSCH) resource, the measurement report.

16. The method of claim 15, wherein:
the configuration includes a RS resource setting for the one or more RS resources; and
the information includes a codepoint mapped to the RS resource setting.

17. The method of claim 16, wherein:
the indicator is one of:
a one-bit acknowledgement, or
a codepoint mapped to a trigger state associated with the RS resource setting; and
the one or more RSs correspond to the a subset of one or more RS resources.

18. The method of claim 15, wherein the second message is:
a downlink control information (DCI);
received within a time duration (T_{offset}) from an end of transmission of the first message, and
the T_{offset} is provided in the configuration.

19. The method of claim 15, wherein:
the PUSCH resource starts no earlier than a time game (T_{gap}) from an end of the PUCCH resource, and
the T_{gap} is provided in the configuration or indicated by the indicator.

20. The method of claim 15, wherein:
the one or more RSs are received within a time duration (T_{proc}) after reception of the second message, and
the T_{proc} is provided in the configuration.
